(19) United States
(12) Patent Application Publication
(10) Pub. No.: US 2024/0177724 A1
(43) Pub. Date: May 30, 2024

(54) CODING AND DECODING OF PULSE AND RESIDUAL PARTS OF AN AUDIO SIGNAL

(71) Applicant: Fraunhofer-Gesellschaft zur Förderung der angewandten Forschung e.V., München (DE)

(72) Inventor: Goran MARKOVIC, Erlangen (DE)

(21) Appl. No.: 18/406,351

(22) Filed: Jan. 8, 2024

Related U.S. Application Data
(63) Continuation of application No. PCT/EP2022/069812, filed on Jul. 14, 2022.

(30) Foreign Application Priority Data
Jul. 14, 2021 (EP) 21185669.5

(51) Int. Cl. G10L 19/083; G10L 19/032; G10L 21/10; G10L 25/18

(52) U.S. Cl. CPC G10L 19/083; G10L 19/032; G10L 21/10; G10L 25/18

(57) ABSTRACT

An audio encoder for encoding an audio signal comprising an pulse portion and a stationary portion, comprises: a pulse extractor configured for extracting the pulse portion from the audio signal, further comprising a pulse coder for encoding the extracted pulse portion to acquire an encoded pulse portion; wherein the pulse extractor is configured to determine a spectrogram of the audio signal to extract the pulse portion, wherein the spectrogram has higher time resolution than the signal encoder; a signal encoder configured for encoding a residual signal derived from the audio signal to acquire an encoded residual signal, the residual signal being derived from the audio signal so that the pulse portion is reduced or eliminated from the audio signal; and an output interface configured for outputting the encoded pulse portion and the encoded residual signal to provide an encoded signal.

### CROSS-REFERENCE TO RELATED APPLICATIONS

This application is a continuation of copending International Application No. PCT/EP2022/069812, filed Jul. 14, 2022, which is incorporated herein by reference in its entirety, and additionally claims priority from European Application No. 21185669.5, filed Jul. 14, 2021, which is also incorporated herein by reference in its entirety.

Embodiments of the present invention refer to an encoder and to a corresponding method for encoding an audio signal. Further embodiments refer to a decoder and to a corresponding method for decoding. Embodiments refer to an improved approach for a pulse extraction and coding, e.g., in combination with an MDCT codec.

### BACKGROUND OF THE INVENTION

MDCT domain codecs are well suited for coding music signals as the MDCT provides decorrelation and compaction of the harmonic components commonly produced by instruments and singing voice. This MDCT property deteriorates if transients (short bursts of energy) are present in the signal. This is the case even in low-pitched speech or singing, where the signal may be considered as filtered train of glottal pulses.

Traditional MDCT codecs (e.g. MP3, AAC) use switching to short blocks and Temporal Noise Shaping (TNS) for handling transient signals. However, there are problems with these techniques. Time Domain Aliasing (TDA) in the MDCT significantly limits the TNS. Short blocks deteriorate signals that are both harmonic and transient. Both methods are very limited for modelling train of glottal pulses in low-pitched speech.

Within conventional technology, some coding principles, especially for MDCT codec are known.

In [1] an algorithm for the detection and extraction of transient signal components is presented. For each band in a complex spectrum (MDCT+MDST) a temporal envelope is generated. Using the temporal envelope, onset durations and weighting factors are calculated in each band. Locations of tiles in the time frequency domain of steep onsets are found using the onset durations and weighting factors, also considering neighboring bands. The tiles of the steep onsets are marked as transients, if they fulfill certain threshold criteria. The tiles in the time frequency domain marked as transient are combined to a separate signal. The extraction of the transients is achieved by multiplying the MDCT coefficients with cross fade factors. The coding of the transients is done in the MDCT domain. This saves the additional inverse MDCT to calculate the transient time signal. The encoded transient signal is decoded and the resulting time domain signal is subtracted from the original signal. The residuum can also be coded with a transform based audio coder.

In [2] an audio encoder includes an impulse extractor for extracting an impulse-like portion from an audio signal. A residual signal is derived from the original audio signal so that the impulse-like portion is reduced or eliminated in the residual audio signal. The impulse-like portion and the residual signal are encoded separately and both are transmitted to the decoder where they are separately decoded and combined. The impulse-like portion is obtained by an LPC synthesis of an ideal impulse-like signal, where the ideal impulse-like signal is obtained via a pure peak picking and the impulse characteristic enhancement from the prediction error signal of an LPC analysis. The pure peak picking means that an impulse, starting from some samples to the left of the peak and ending at some samples to the right of the peak, is picked out from the signal and the signal samples between the peaks are completely discarded. The impulse characteristic enhancement processes the peaks so that each peak has the same height and shape.

In [3] High Resolution Envelope Processing (HREP) is proposed that works as a pre-processor that temporally flattens the signal for high frequencies. At the decoder-side, it works as a post-processor that temporally shapes the signal for high frequencies using the side information.

In [4] the original and the coded signal are decomposed into semantic components (i.e., distinct transient clap events and more noise-like background) and their energies are measured in several frequency bands before and after coding. Correction gains derived from the energy differences are used to restore the energy relations in the original signal by post-processing via scaling of the separated transient clap events and noise-like background signal for band-pass regions. Pre-determined restauration profiles are used for the post-processing.

In [5] a harmonic-percussive-residual separation using structure tensor on log spectrogram is presented. However the paper doesn't consider audio/speech coding.

The European Parent applications 19166643.7 forms additional conventional technology. The applications refers to concepts for generating a frequency enhanced audio signal from a source audio signal.

Below an analysis of the conventional technology will be given, wherein the analysis of the conventional technology and it's drawback is part of the embodiments, since the solution as it is described in context of the embodiments is based on this analysis.

The methods in [3] and [4] don't consider separately coding transient events and thus don't use any advantage that a specialized codec for transients and a specialized codec for residual/stationary signals could have.

In [2] any error introduced by performing the impulse characteristic enhancement is accounted for in the residual coder. Since the impulse characteristic enhancement processes the peaks so that each peak has the same height and shape, this leads to the error containing differences between the impulses and these differences have transient characteristics. Such error with transient characteristics is not well suited for the residual coder, which expects stationary signal. Let us now consider a signal consisting of a superposition of a strong stationary signal and a small transient. Since all samples at the location of the peak are kept and all samples between peaks are removed, it means that the impulse will contain the small transient and a time-limited part of the strong stationary signal and the residual will have a discontinuity at the location of the transient. For such signal neither the “impulse-like” signal is suited for the pulse coder nor is the “stationary residual” suited for the residual coder. Another drawback of the method in [2] is that it is adequate only for train of impulses and not for single transients.

In [1] only onsets are considered and thus transient events like glottal pulses would not be considered or would be inefficiently coded. By using linear magnitude spectrum and by using separate envelopes for each band, broad-band transients may be missed in a presence of a background noise/signals. Therefore there is the need for an improved approach.

### SUMMARY

According to an embodiment, an audio encoder for encoding an audio signal may have: a pulse extractor configured for extracting a pulse portion from the audio signal wherein the pulse extractor is configured to determine a spectrogram of the audio signal to extract the pulse portion; a pulse coder for encoding the extracted pulse portion to acquire an encoded pulse portion; a signal encoder configured for encoding a residual signal derived from the audio signal to acquire an encoded residual signal, the residual signal being derived from the audio signal by reducing or eliminating the pulse portion from the audio signal; wherein the spectrogram has higher time resolution than the signal encoder; and an output interface configured for outputting the encoded pulse portion and the encoded residual signal to provide an encoded signal.

According to another embodiment, a method for encoding an audio signal may have the steps of: extracting a pulse portion from the audio signal by determining a spectrogram of the audio signal, wherein the spectrogram has higher time resolution than a signal encoder; encoding the extracted pulse portion to acquire an encoded pulse portion; encoding a residual signal derived from the audio signal to acquire an encoded residual signal, the residual signal being derived from the audio signal by reducing or eliminating the pulse portion from the audio signal; and outputting the encoded pulse portion and the encoded residual signal to provide an encoded signal.

According to another embodiment, a decoder for decoding an encoded audio signal including an encoded pulse portion and an encoded residual signal may have: a pulse decoder configured for using a decoding algorithm adapted to a coding algorithm used for generating the encoded pulse portion to acquire a decoded pulse portion; a signal decoder configured for using a decoding algorithm adapted to a coding algorithm used for generating the encoded residual signal to acquire the decoded residual signal; and a signal combiner configured for combining the decoded pulse portion and the decoded residual signal to provide a decoded output signal; wherein the signal decoder and the pulse decoder are operative to provide output values related to the same time instance of a decoded signal;

and the signal decoder operates in the frequency domain including frequency to time transform; and wherein the decoded pulse portion consists of pulse waveforms located at specified time portions, an information on the specified time portions being a part of the encoded pulse portion; and wherein the encoded pulse portion includes parameters for presenting spectrally flattened pulse waveforms; and wherein the decoded pulse portion consists of pulse waveforms and the pulse decoder is configured to obtain the pulse waveforms by spectrally shaping spectrally flattened pulse waveforms using a spectral envelope common to pulse waveforms close to each other.

According to another embodiment, a method for decoding an encoded audio signal including an encoded pulse portion and an encoded residual signal may have the steps of:

using a pulse decoding algorithm adapted to a coding algorithm used for generating the encoded pulse portion to acquire a decoded pulse portion; using a signal decoding algorithm adapted to a coding algorithm used for generating the encoded residual signal to acquire the decoded residual signal; and combining the decoded pulse portion and the decoded residual signal to provide a decoded output signal; wherein the signal decoding algorithm is operative to provide output values related to the same time instance of a decoded signal; and the signal decoding algorithm operates in the frequency domain including frequency to time transform; and wherein the decoded pulse portion consists of pulse waveforms located at specified time portions, an information on the specified time portions being a part of the encoded pulse portion; and wherein the encoded pulse portion includes parameters for presenting spectrally flattened pulse waveforms; and wherein the decoded pulse portion consists of pulse waveforms and the pulse decoding algorithm is operative to obtain the pulse waveforms by spectrally shaping spectrally flattened pulse waveforms using a spectral envelope common to pulse waveforms close to each other.

Another embodiment may have a non-transitory digital storage medium having a computer program stored thereon to perform any of the inventive methods when said computer program is run by a computer.

Embodiments of the present invention provide an audio encoder for encoding an audio signal which comprises an pulse portion and a stationary portion. The audio encoder comprises an pulse extractor, a signal encoder as well as an output interface. The pulse extractor is configured for extracting the pulse portion from the audio signal and further comprises an pulse coder for encoding the pulse portion to acquire an encoded pulse portion. The pulse extractor is configured to determine a spectrogram, for example a magnitude spectrogram and a phase spectrogram, of the audio signal to extract the pulse portion. For example the spectrogram may have a higher time resolution than the signal encoder. The signal encoder is configured for encoding a residual signal derived from the audio signal (after extracting the pulse portion) to acquire an encoded residual signal. The residual signal is derived from the audio signal so that the pulse portion is reduced or eliminated from the audio signal. The interface is configured for outputting the encoded pulse signal (signal describing the coded pulse waveform (e.g. by use of parameters) and the encoded residual signal to provide an encoded signal. Note—according to embodiments—the residual signal is the signal obtained when (by/after) extracting the pulse portion from the audio signal so that the pulse portion in the residual signal is reduced or eliminated.

According to embodiments, the pulse coder is configured for providing an information (e.g. in the way that a number of pulses in the frame N_{PC} is set to 0) that the encoded pulse portion is not present when the pulse extractor is not able to find a pulse portion in the audio signal. According to embodiments, wherein the spectrogram having higher time resolution than the signal encoder.

Embodiments of the present invention are based on the finding that the encoding performance and especially the quality of the encoded signal is significantly increased when a pulse portion is encoded separately. For example, the stationary portion may be encoded after extracting the pulse portion, e.g., using an MDCT domain codec. The extracted pulse portion is coded using a different coder, e.g., using a time-domain. The pulse portion (a train of pulses or a transient) is determined using a spectrogram of the audio signal, wherein the spectrogram has higher time resolution than the signal encoder. For example, a non-linear (log) magnitude spectrogram and/or phase spectrogram may be used. By using non-linear magnitude spectrum broad-band transients can accurately be determined, even in presence of a background noise/signals.

For example, a pulse portion may consist out of pulse waveforms having high-pass characteristics located at/near peaks of a temporal envelope obtained from the spectrogram. According to a further embodiment, an audio encoder is provided, wherein the pulse extractor is configured to obtain the pulse portion consisting of pulse waveforms or waveforms having high-pass characteristics located at peaks of a temporal envelope obtained from the spectrogram of the audio signal. According to embodiments, the pulse extractor is configured to determine a magnitude spectrogram or a non-linear magnitude spectrogram and/or a phase spectrogram or a combination thereof in order to extract the pulse portion. According to embodiments, the pulse extractor is configured to obtain the temporal envelope by summing up values of a magnitude spectrogram in one time instance; additionally or alternatively, the temporal envelope may be obtained by summing up values of a non-linear magnitude spectrogram in one time instance. According to another embodiment, the pulse extractor is configured to obtain the pulse portion (consisting of pulse waveforms) from a magnitude spectrogram and/or a phase spectrogram of the audio signal by removing the stationary portion of the audio signal in all time instances of the magnitude/phase spectrogram.

According to embodiments, the encoder further comprises a filter configured to process the pulse portion so that each pulse waveform of the pulse portion comprises a high-pass characteristic and/or a characteristic having more energy at frequencies starting above a start frequency. Alternatively or additionally, the filter is configured to process the pulse portion so that each pulse waveform of the pulse portion comprises a high-pass characteristic and/or a characteristic having more energy at frequencies starting above a start frequency, where the start frequency being proportional to the inverse of the average distance between the nearby pulse waveforms. It can happen that the stationary portion also has high-pass characteristic independent of how the pulse portion is extracted. However the high-pass characteristic in the residual signal is removed or reduced compared to the audio signal if the pulse portion is found and removed or reduced from the audio signal.

According to embodiments, the encoder further comprises means (e.g. pulse extractor, background remover, pulse locator finder or a combination thereof) for processing the pulse portion such that each pulse waveform has a characteristic of more energy near its temporal center than away from its temporal center or such that the pulses or the pulse waveforms are located at or near peaks of a temporal envelope obtained from the spectrogram of the audio signal.

According to embodiments, the pulse extractor is configured to obtain at least one sample of the temporal envelope or the temporal envelope in at least one time instance by summing up values of a magnitude spectrogram in at least one time instance and/or by summing up values of a non-linear magnitude spectrogram in at least one time instance.

According to further embodiments the pulse waveform has a specific characteristic of more energy near its temporal center when compared away from the temporal center.

Accordingly, the pulse extractor may be configured to determine the pulse portion based on this characteristic. Note, the pulse portion may consist of potentially multiple pulse waveforms. That a pulse waveform has more energy near its temporal center is a consequence of how they are found and extracted.

According to further embodiments, each pulse waveform comprises high-pass characteristics and/or a characteristics having more energy at frequencies starting above a start frequency. Note the start frequency may be proportional to the inverse of the average distance between the nearby pulse waveforms.

According to further embodiments, the pulse extractor is configured to determine pulse waveforms belonging to the pulse portion dependent on one of the following:
a correlation between pulse waveforms, and/or
a distance between the pulse waveforms, and/or
a relation between the energy of the pulse waveforms and the audio or residual signal.

According to further embodiments, the pulse extractor comprises a further encoder configured to code the extracted pulse portion by a spectral envelope common to pulse waveforms close to each other and by parameters for presenting a spectrally flattened pulse waveform. According to further embodiments, the encoder further comprises a coding entity configured to code or code and quantize a gain for the (complete) prediction residual, Here, an optional correction entity may be used which is configured to calculate for and/or apply a correction factor to the gain for the (complete) prediction residual.

This encoding approach may be implemented by a method for encoding an audio signal comprising the pulse portion and a stationary portion. The method comprises the four basic steps:
extracting the pulse portion from the audio signal by determining a spectrogram of the audio signal, wherein the spectrogram having higher time resolution than the signal encoder
encoding the extracted pulse portion to acquire an encoded pulse portion;
encoding a residual signal derived from the audio signal to acquire an encoded residual signal, the residual signal being derived from the audio signal so that the pulse portion is reduced or eliminated from the audio signal; and
outputting the encoded pulse portion and the encoded residual signal to provide an encoded signal.

Another embodiment provides a decoder for decoding an encoded audio signal, comprising an encoded pulse portion and an encoded residual signal. The decoder comprises an impulse decoder and a signal decoder as well as a signal combiner. Pulse decoder is configured for using a decoding algorithm, e.g. adapted to a coding algorithm used for generating the encoded pulse portion to acquire a decoded pulse portion. The signal decoder is configured for using a decoding algorithm adapted to a coding algorithm used for generating the encoded residual signal to acquire the decoded residual signal. The combiners are configured to combine the decoded pulse portion and the decoded residual signal to provide a decoded output signal.

As discussed above, the decoded pulse portion may consist of pulse waveforms located at specified time locations. Alternatively, the encoded pulse portion includes a parameter for presenting a spectrally flattened pulse waveforms wherein each pulse waveform has a characteristic of more energy near its temporal center than away from its temporal center.

According to embodiments, the signal decoder and the impulse decoder are operative to provide output values related to the same time instance of a decoded signal.

According to embodiments the pulse coder is configured to obtain the spectrally flattened pulse waveforms, e.g. having spectrally flattened magnitudes of a spectrum associated with the pulse waveform, or a pulse STFT. On the decoder side the spectrally flattened pulse waveforms can be obtained using a prediction from a previous pulse waveform or a previous flattened pulse waveform. According to further embodiments, the impulse decoder is configured to obtain the pulse waveforms by spectrally shaping the spectrally flattened pulse waveforms using spectral envelope common to pulse waveforms close to each other.

According to embodiments, the decoder further comprising a harmonic post-filtering. For example the harmonic post-filtering may be implanted as disclosed by [9]. Alternatively, the HPF may be configured for filtering the plurality of overlapping sub-intervals, wherein the harmonic post-filter is based on a transfer function comprising a numerator and a denominator, where the numerator comprises a harmonicity value, and wherein the denominator comprises a pitch lag value and the harmonicity value and/or a gain value.

According to embodiments, the pulse decoder is configure to decode the pulse portion of a current frame taking into account the pulse portion or pulse portions of one or more frames previous to the current frame.

According to embodiments, the pulse decoder is configure to decode the pulse portion taking into account a prediction gain ( [symbol] ); here the prediction gain ( [symbol] ) may be directly extracted from the encoded audio signal.

According to further embodiments, the decoding may be performed by a method for decoding an encoded audio signal comprising an encoded pulse portion and an encoded residual signal. The method comprising the three steps:
using a decoding algorithm adapted to a coding algorithm used for generating the encoded pulse portion to acquire a decoded pulse portion;
using a decoding algorithm adapted to a coding algorithm used for generating the encoded residual signal to acquire the decoded residual signal; and
combining the decoded pulse portion and the decoded residual signal to provide a decoded output signal.

Above embodiments may also be computer implemented. Therefore, another embodiment refers to a method for performing when running on a computer, the method for decoding and/or encoding.

### BRIEF DESCRIPTION OF THE DRAWINGS

Embodiments of the present invention will be detailed subsequently referring to the appended drawings, in which:

FIG. 1a shows schematic representation of a basic implementation of a codec consisting of an encoder and a decoder according to an embodiment;

FIGS. 1b-1d show three time-frequency diagrams for illustrating the advantages of the proposed approach according to an embodiment;

FIG. 2a shows a schematic block diagram illustrating an encoder and according to an embodiment and a decoder according to another embodiment;

FIG. 2b shows a schematic block diagram illustrating an excerpt of FIG. 2a comprising the encoder according to an embodiment;

FIG. 2c shows a schematic block diagram illustrating excerpt of FIG. 2a comprising the decoder according to another embodiment;

FIG. 3 shows a schematic block diagram of a signal encoder for the residual signal according to embodiments;

FIG. 4 shows a schematic block diagram of a decoder comprising the principle of zero filling according to further embodiments;

FIG. 5 shows a schematic diagram for illustrating the principle of determining the pitch contour (cf. block gap pitch contour) according to embodiments;

FIG. 6 shows a schematic block diagram of a pulse extractor using an information on a pitch contour according to further embodiments;

FIG. 7 shows a schematic block diagram of a pulse extractor using the pitch contour as additional information according to an alternative embodiment;

FIG. 8 shows a schematic block diagram illustrating a pulse coder according to further embodiments;

FIGS. 9a-9b show schematic diagrams for illustrating the principle of spectrally flattening a pulse according to embodiments;

FIG. 10 shows a schematic block diagram of a pulse coder according to further embodiments;

FIGS. 11a-11b show a schematic diagram illustrating the principle of determining a prediction residual signal starting from a flattened original;

FIG. 12 shows a schematic block diagram of a pulse coder according to further embodiments;

FIG. 13 shows a schematic diagram illustrating a residual signal and coded pulses for illustrating embodiments;

FIG. 14 shows a schematic block diagram of a pulse decoder according to further embodiments;

FIG. 15 shows a schematic block diagram of a pulse decoder according to further embodiments;

FIG. 16 shows a schematic flowchart illustrating the principle of estimating an optimal quantization step (i.e. step size) using the block IBPC according to embodiments;

FIGS. 17a-17d show schematic diagrams for illustrating the principle of long-term prediction according to embodiments;

FIGS. 18a-18d show schematic diagrams for illustrating the principle of harmonic post-filtering according to further embodiments.

### DETAILED DESCRIPTION OF THE INVENTION

Below, embodiments of the present invention will subsequently be discussed referring to the enclosed figures, wherein identical reference numerals are provided to objects having identical or similar functions, so that the description thereof is mutually applicable and interchangeable.

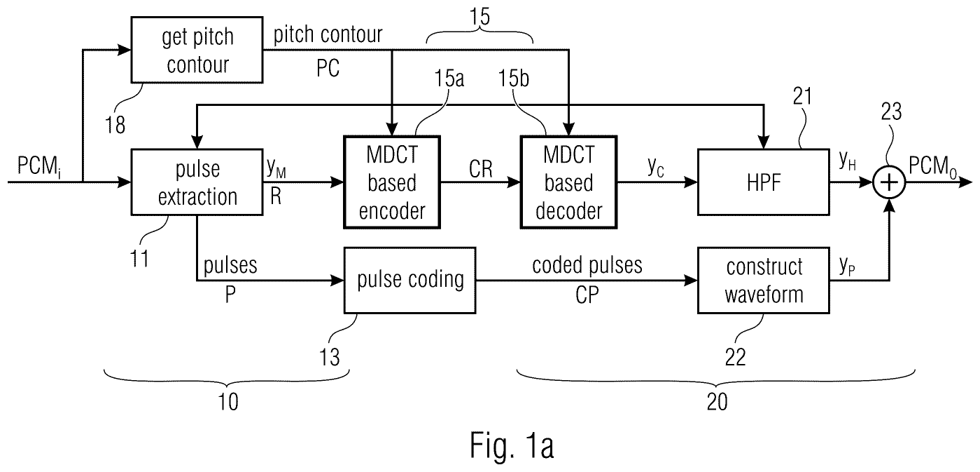

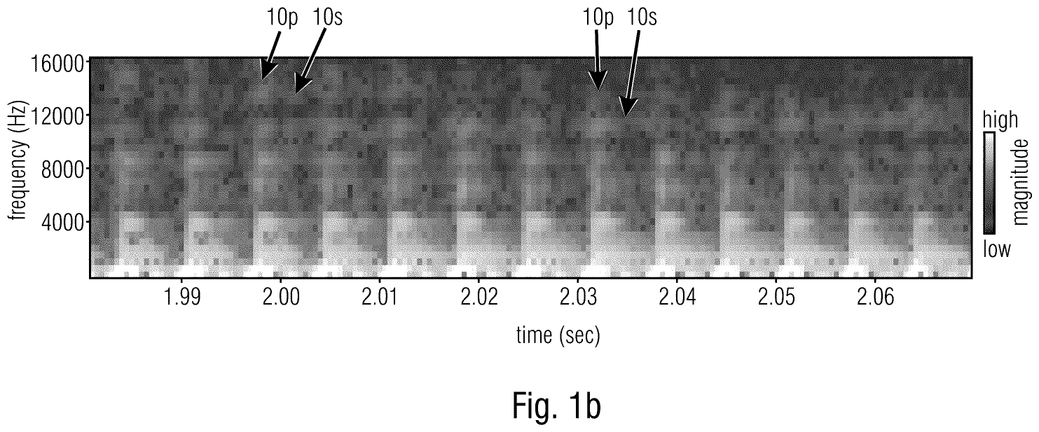

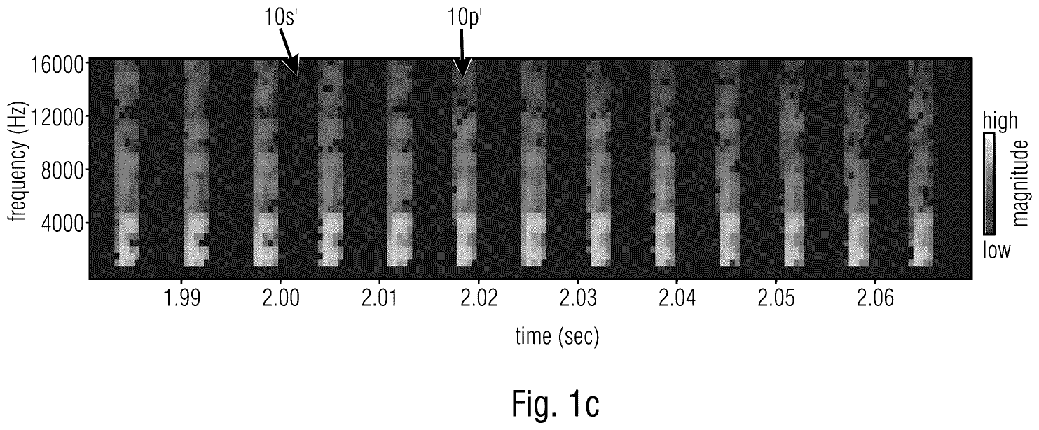

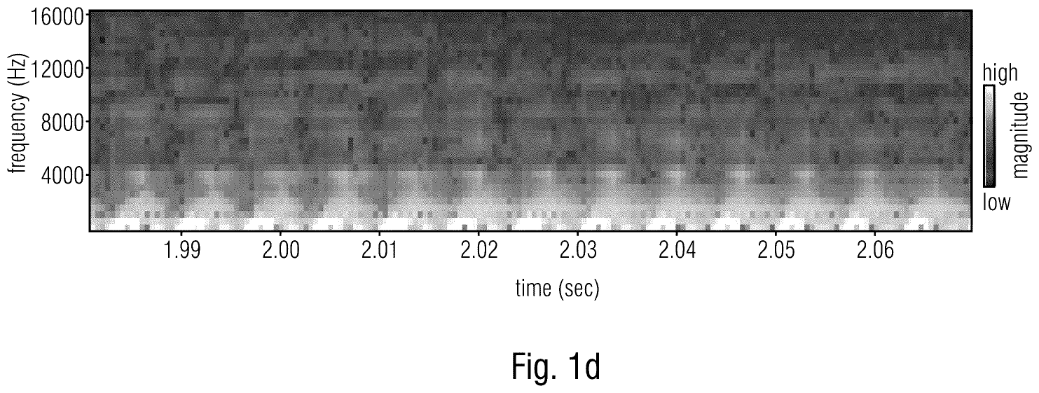

FIG. 1a shows an apparatus 10 for encoding and decoding the PCM, signal. The apparatus 10 comprises a pulse extractor 11, a pulse coder 13 as well as a signal codec 15, e.g. a frequency domain codec or an MDCT codec. The codec comprises the encoder side (15a) and the decoder side (15b). The codec 15 uses the signal y M (residual after performing the pulse extraction (cf. entity 11)) and an information on the pitch contour PC determined using the entity 18 (Get pitch contour).

Furthermore, with respect to FIG. 1a a corresponding decoder 20 is illustrated. It comprises at least the entities 22, 23 and parts of 15, wherein the unit HPF marked by the reference number 21 is an optional entity. In general, it should be noted, that some entities may consist out of one of more elements, wherein not all elements are mandatory.

Below, a basic implementation of the audio encoder will be discussed without taking focus on their optional elements. The pulse extractor 11 receives an input audio signal POW Optionally the signal PCM, may be an output of an LP analysis filtering. This signal PCM, is analyzed, e.g., using a spectrogram like a magnitude spectrogram, non-linear magnitude spectrogram or a phase spectrogram so as to extract the pulse portion of the PCM, signal. Note to enable a good pulse determination within the spectrogram, the spectrogram may optionally have a higher time resolution than the signal codec 15. This extracted pulse portion is marked as pulses P and forwarded to the pulse coder 13. After the pulse extracting 11 the residual signal R is forwarded to the signal codec 15.

The higher time resolution of the spectrogram than the signal codec means that there are more spectra in the spectrogram than there are sub-frames in a frame of the signal codec. For an example, in the signal codec operating in a frequency domain, the frame may be divided into 1 or more sub-frames and each sub-frame may be coded in the frequency domain using a spectrum and the spectrogram has more spectra within the frame than there are there signal codec spectra within the frame. The signal codec may use signal adaptive number of sub-frames per frame. In general it is advantageous that the spectrogram has more spectra per frame that the maximum number of sub-frames used by the signal codec. In an example there may be 50 frames per second, 40 spectra of the spectrogram per frame and up to 5 sub-frames of the signal codec per frame.

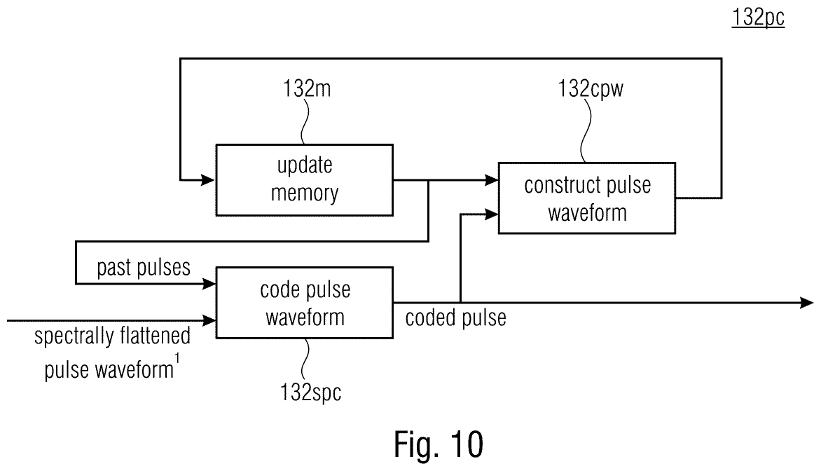

The pulse coder 13 is configured to encode the extracted pulse portion P so as to output an encoded pulse portion and output the coded pulses CP. According to embodiments, the pulse portion (comprising a pulse waveform) may be encoded using the current pulse portion (comprising a pulse waveform) and one or more past pulse waveforms, as will be discussed with respect to FIG. 10

The signal codec 15 is configured to encode the residual signal R to acquire an encoded residual signal CR. The residual signal is derived from the audio signal PCM_{I}, so that the pulse portion is reduced or eliminated from the audio signal PCM_{I}. It should be noted, that according to embodiments, the signal codec 15 for encoding the residual signal R is a codec configured for coding stationary signals or that it is a frequency domain codec, like an MDCT codec. According to embodiments, this MDCT based codec 15 uses a pitch contour information PC for the coding. This pitch contour information is obtained directly from the PCM_{I} signal by use of a separate entity marked by the reference number 18 “get pitch contour”.

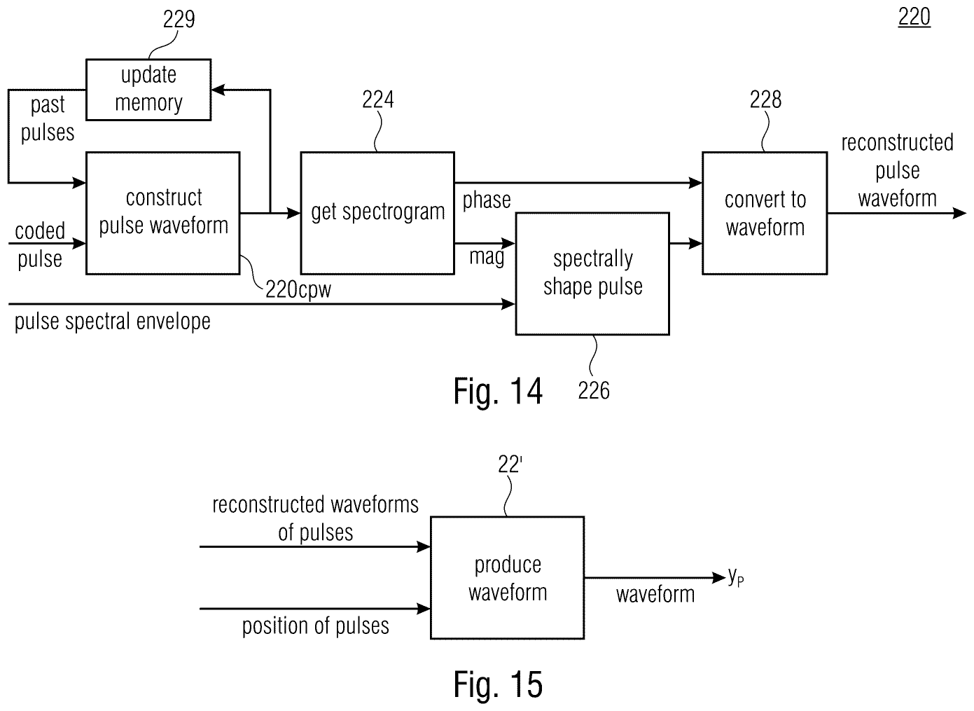

For the sake of completeness, a decoder 20 is illustrated. The decoder 20 comprises the entities 22, 23, parts of 15 and optionally the entity 21. The entity 22 is used for decoding and reconstructing the pulse portion consisting of reconstructed pulse waveforms. The reconstruction of the current reconstructed pulse waveform may be performed taking into account past pulses as shown in 220. This approach using a prediction will be discussed in a context of FIGS. 15 and 14. The process performed by the entity 220 of FIG. 14 is performed multiple times (for each reconstructed pulse waveform) producing the reconstructed pulse waveforms, that are input to the entity 22′ of FIG. 15. The entity 22′ constructs the waveform y_{P} (i.e. the reconstructed pulse portion or the decoded pulse portion), consisting of the reconstructed pulse waveforms placed at positions of pulses obtained from the coded pulses CP. In parallel to the pulse decoder, the MDCT codec entity 15 is used for decoding the residual signal. The decoded residual signal may be combined with the decoded pulse portion y_{P} in the combiner 23. The combiner combines the decoded pulse portion and the decoded residual signal to provide a decoded output signal PCM_{O}. Optionally an HPF entity 21 for harmonic post-filtering may be arranged between the combiner 23 and the MDCT decoder 15 or alternatively at the output of the combiner 23.

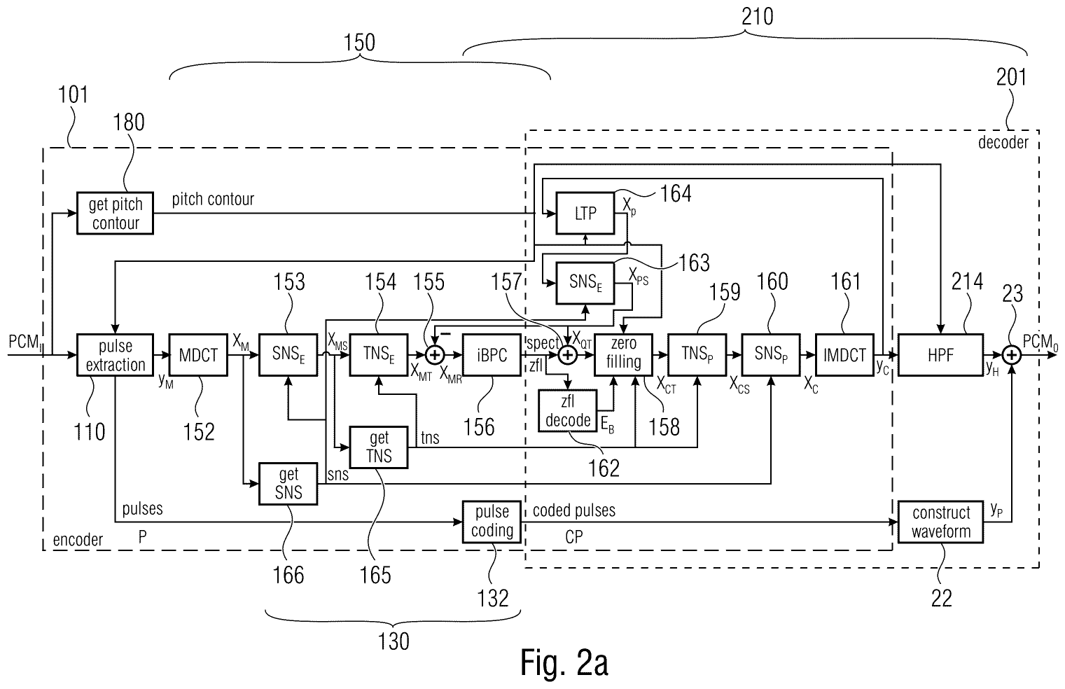

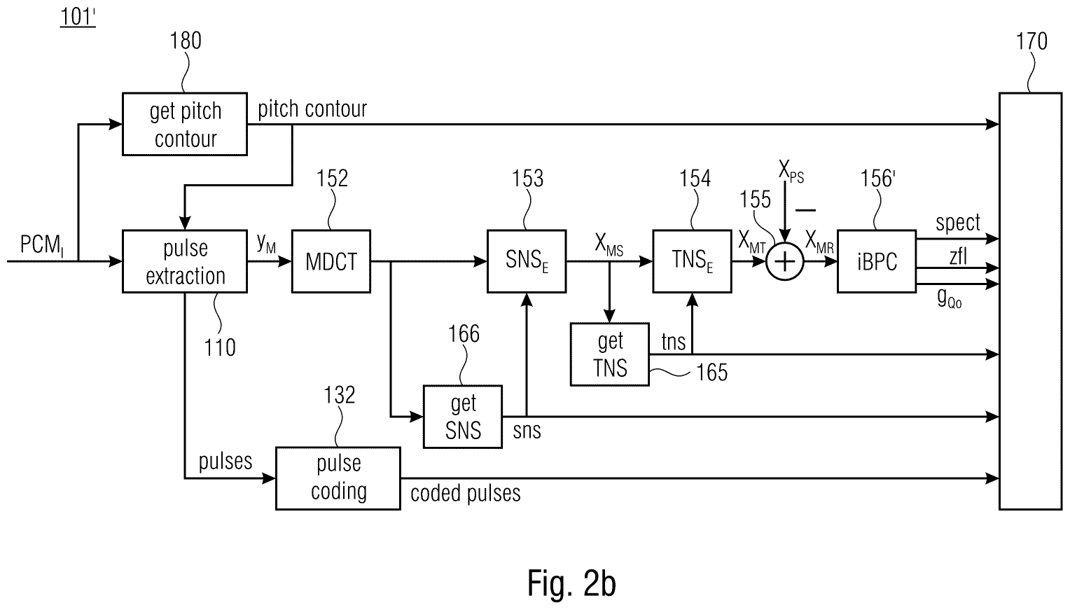

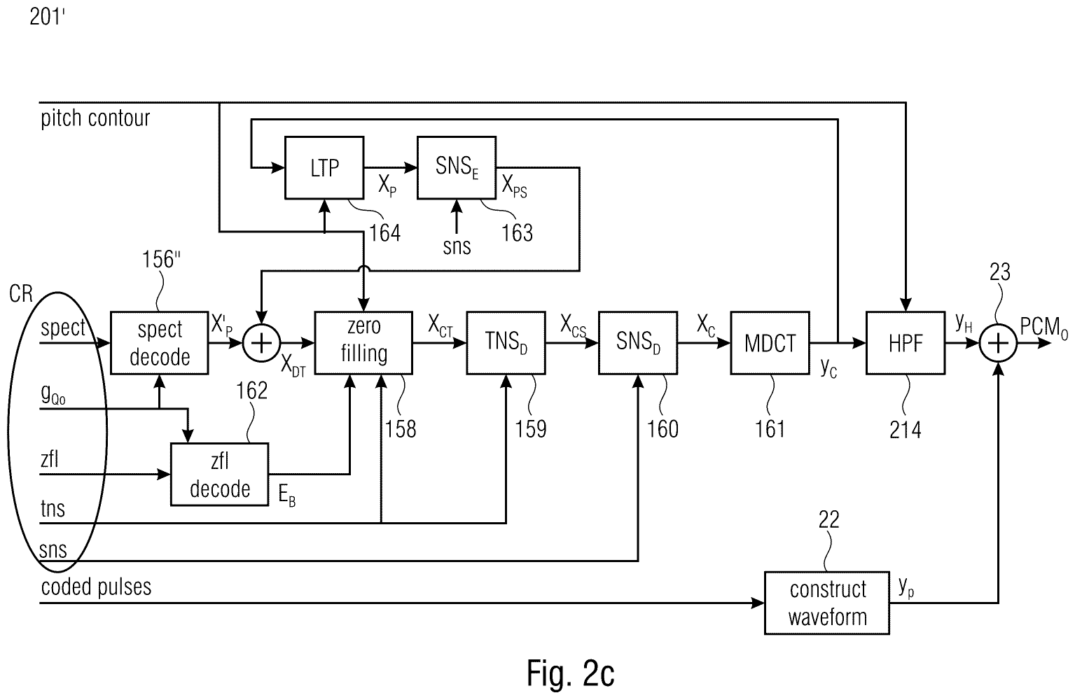

The pulse extractor 11 corresponds to the entity 110, the pulse coder 13 corresponds to the entity 132 in FIGS. 2a and 2b. The entities 22 and 23 are also shown in FIGS. 2a and 2c.

To sum up the signal decoder 20 is configured for using a decoding algorithm adapted to a coding algorithm used for generating the encoded residual signal to acquire the decoded residual signal which is provided to the signal combiner 23.

Below, an enhanced description of the pulse extraction mechanism performed by the entity 110 will be given.

According to embodiments, the pulse extraction (cf. entity 110) obtains an STFT of the input audio signal, and uses a non-linear (log) magnitude spectrogram and a phase spectrogram of the STFT to find and extract pulses/transients, each pulse/transient having a waveform with high-pass characteristics. Peaks in a temporal envelope are considered as locations of the pulses/transients, where the temporal envelope is obtained by summing up values of the non-linear magnitude spectrogram in one time instance. Each pulse/transient extends 2 time instances to the left and 2 to the right from its temporal center location in the SIFT.

A background (stationary part) may be estimated in the non-linear magnitude spectrogram and removed in the linear magnitude domain. The background is estimated using an interpolation of the non-linear magnitudes around the pulses/transients.

According to embodiments, for each pulse/transient, a start frequency may be set so that it is proportional to the inverse of the average pulse distance among nearby pulses. The linear-domain magnitude spectrogram of a pulse/transient below the start frequency is set to zero.

According to embodiments, the pulse coder is configured to spectrally flatten magnitudes of the pulse waveform or a pulse STFT (or e.g. of the spectrogram) using a spectral envelope. Alternatively a filter processor may be configured to spectrally flatten the pulse waveform by filtering the pulse waveform in the time domain. Another variant is that the pulse coder is configured to obtain a spectrally flattened pulse waveform from a spectrally flattened STFT via inverse DFT, window and overlap-and-add. According to embodiments, a pulse waveform is obtained from the STFT via inverse DFT, window and overlap-and-add.

A probability of a pulse pair belonging to a train of pulses may—according to embodiments—be calculated from:
Correlation between waveforms of the pulses/transients
Error between distance of two pulses and a pitch lag from a pitch analysis

According to embodiments, a probability of a pulse may be calculated from:
Ratio of the pulse energy to the local energy
Probability that it belongs to a train of pulses

Pulses with the probability above a threshold are coded and their original non-coded waveforms may be subtracted from the input audio signal.

According to embodiments, the pulses P may be coded by the entity 130 as follows: number of pulse waveforms within a frame, positions/locations, start frequencies, a spectral envelope, prediction gains and sources, innovation gains and innovation impulses.

For example, one spectral envelope is coded per frame, presenting average of the spectral envelopes of the pulses in the frame. The magnitudes of the pulse STFT are spectrally flattened using the spectral envelope. Alternatively, a spectral envelope of the input signal ay be used for both: the pulse (cf. entity 130) and the residual. (cf. entity 150)

The spectrally flattened pulse waveform may be obtained from the spectrally flattened STFT via inverse DFT, window and overlap-and-add.

The most similar previously quantized pulse may be found and a prediction constructed from the most similar previous pulse is subtracted from the spectrally flattened pulse waveform to obtain the prediction residual, where the prediction is multiplied with a prediction gain.

For example, the prediction residual is quantized using up to four impulses, where impulse positions and signs are coded. Additionally an innovation gain for the (complete) prediction residual may be coded. Note complete prediction residual refers, for example, to the up to four impulses, that is one innovation gain is found and applied to all impulses. Thus, complete prediction residual can refer to the characteristics that the quantized prediction residual consists of the up to four impulses and one gain. Nevertheless in another implementation there could be multiple gains, for example one gain for each impulse. In yet another example there can be more than four impulses, for example the maximum number of impulses could be proportional to the codec bitrate.

According to embodiments the initial prediction and the innovation gain maximize SNR and may introduce energy reduction. Thus, a correction factor is calculated and the gains are multiplied with the correction factor to compensate energy reduction. The gains may be quantized and coded after applying the correction factor with no change in the choice of the prediction source or impulses.

In the decoder, the impulses are—according to embodiments—decoded and multiplied with the innovation gain to produce the innovation. A prediction is constructed from the most similar previous pulse/transient and multiplied with the prediction gain. The prediction is added to the innovation to produce the flattened pulse waveform, which is spectrally shaped by the decoded spectral envelope to produce the pulse waveform.

The pulse waveforms are added to the decoded MDCT output at the locations decoded from the bit-stream.

Note, the pulse waveforms have their energy concentrated near the temporal center of the waveform.

With respect to FIGS. 1b, 1c and 1d, the advantages of the proposed method will be discussed.

Thanks to the integration of the non-linear magnitudes over the whole bandwidth, dispersed transients (including pulses) can be detected even in a presence of a background signal/noise. FIG. 1b illustrates a spectrogram (frequency over time), wherein different magnitude values are illustrated by a different shading. Some portions representing pulses are marked by the reference sign 10p. Between these pulse portions 10p stationary portions 10s are marked.

By removing the stationary parts from the magnitude spectrogram of the pulses (cf. FIG. 1c), almost only parts that are suited for an MDCT coder are removed from (cf. reference numeral 10s′) from the input signal. By not modifying non-stationary parts of the magnitude spectrum of the pulses, almost all parts not suited for an MDCT coder are removed from the input signal (cf. FIG. 1d).

Signals with shorter distance between pulses of a pulse train have higher F0 and bigger distance between the harmonics, thus coding them with the MDCT coder is efficient. Such signals also exhibit less masking of broad-band transients. By increasing the pulse/transient starting frequency for shorter distance between pulses, errors in the extraction or coding of the pulses is made less disturbing.

Using the prediction from a single pulse/transient to a single pulse/transient, coding of the pulses/transients is made efficient. By spectral flattening, the changes in the spectral envelope of the pulses/transients are ignored and the usage of the prediction is increased.

Using the correlation between the pulse waveforms in the pulse choice makes sure that the pulses that can be efficiently coded are extracted. Using the ratio of the pulse energy to the local energy in the pulse choice allows that also strong transients, not belonging to a pulse train, are extracted. Thus, any kind of transients, including glottal pulses, that cannot be efficiently coded in the MDCT are removed from the input signal. Below, further embodiments will be discussed.

FIG. 2a shows an encoder 101 in combination with decoder 201.

The main entities of the encoder 101 are marked by the reference numerals 110, 130, 150. The entity 110 performs the pulse extraction, wherein the pulses p are encoded using the entity 132 for pulse coding.

The signal encoder 150 is implemented by a plurality of entities 152, 153, 154, 155, 156, 157, 158, 159, 160 and 161. These entities 152-161 form the main path of the encoder 150, wherein in parallel, additional entities 162, 163, 164, 165 and 166 may be arranged. The entity 162 (zfl decoder) connects informatively the entities 156 (iBPC) with the entity 158 for

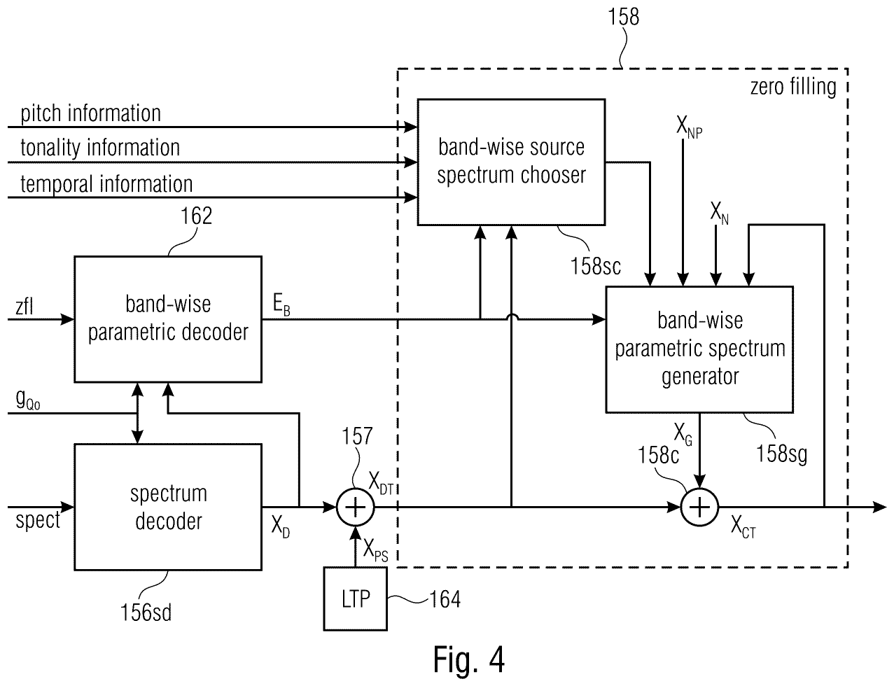

Zero filling. The entity 165 (get TNS) connects informatively the entity 153 (SNS_{E}) with the entity 154, 158 and 159. The entity 166 (get SNS) connects informatively the entity 152 with the entities 153, 163 and 160. The entity 158 performs zero filling an can comprise a combiner 158c which will be discussed in context of FIG. 4. Note there could be an implementation where the entities 159 and 160 do not exist—for example a system with a LP filtering of the MDCT output. Thus, these entities 159 and 160 are optional.

The entities 163 and 164 receive the pitch contour from the entity 180 and the coded residual Y_{C} so as to generate the predicted spectrum X_{P} and/or at the perceptually flattened prediction X_{PS}. The functionality and the interaction of the different entities will be described below.

Before discussing the functionality of the encoder 101 and especially of the encoder 150 a short description of the decoder 210 is given. The decoder 210 may comprise the entities 157, 162, 163, 166, 158, 159, 160, 161 as well as encoder specific entities 214 (HPF), 23 (signal combiner) and 22 (for constructing the waveform). Furthermore, the decoder 201 comprises the signal decoder 210, wherein the entities 158, 159, 160, 161, 162, 163 and 164 form together with the entity 214 the signal decoder 210. Furthermore, the decoder 201 comprises the signal combiner 23.

Below, the encoding functionality will be discussed: The pulse extraction 110 obtains an STFT of the input audio signal POW and uses a non-linear magnitude spectrogram and a phase spectrogram of the STFT to find and extract pulses, each pulse having a waveform with high-pass characteristics. Pulse residual signal y_{M}, is obtained by removing pulses from the input audio signal. The pulses are coded by the Pulse coding 132 and the coded pulses CP are transmitted to the decoder 201.

y_{M}X_{M}L_{M}X_{M}SNS_{E}X_{MS}TNS_{E}X_{MT}ϕ_{H}X_{M}X_{MS}X_{MT}LTPX_{P}X_{PS}X_{MT}LTPX_{MR} The pulse residual signal is windowed and transformed via the MDCT 152 to produce of length. The windows are chosen among 3 windows as in [6]. The longest window is 30 milliseconds long with 10 milliseconds overlap in the example below, but any other window and overlap length may be used. The spectral envelope of is perceptually flattened via 153 obtaining. Optionally Temporal Noise Shaping 154 is applied to flatten the temporal envelope, in at least a part of the spectrum, producing. At least one tonality flag in a part of a spectrum (in or or) may be estimated and transmitted to the decoder 201/210. Optionally Long Term Prediction 164 that follows the pitch contour 180 is used for constructing a predicted spectrum from a past decoded samples and the perceptually flattened prediction is subtracted in the MDCT domain from, producing an residual. A pitch contour 180 is obtained for frames with high average harmonicity and transmitted to the decoder 201/210. The pitch contour 180 and a harmonicity is used to steer many parts of the codec. The average harmonicity may be calculated for each frame.

FIG. 2b shows an excerpt of FIG. 2a with focus on the encoder 101′ comprising the entities 180, 110, 152, 153, 153, 155, 156′, 165, 166 and 132. Note 156 in FIG. 2a is a kind of a combination of 156′ in FIG. 2b and 156″ in FIG. 2c. Note the entity 163 (in FIG. 2a, 2c) can be the same or comparable as 153 and is the inverse of 160.

According to embodiments, the encoder splits the input signal into frames and outputs for example for each frame at least one or more of the following parameters:
pitch contour
MDCT window choice, 2 bits
LTP parameters
coded pulses
sns, that is coded information for the spectral shaping via the SNS
tns, that is coded information for the temporal shaping via the TNS
global gain gQo, that is the global quantization step size for the MDCT codec
spect, consisting of the entropy coded quantized MDCT spectrum
zfl, consisting of the parametrically coded zero portions of the quantized.

The coded residual signal CR may consist of spec and/or g_{Q0} and/or zfl and/or tns and/or sns.

X_{PS} is coming from the LTP which is also used in the encoder, but is shown only in the decoder.

FIG. 2c shows excerpt of FIG. 2a with focus on the encoder 201′ comprising the entities entities 156″, 162, 163, 164, 158, 159, 160, 161, 214, 23 and 22 which have been discussed in context of FIG. 2a. Regarding the LTP 164. Basically, LTP is a part of the decoder (except HPF, “Construct waveform” and their outputs), it may be also used/needed in the encoder (as part of an internal decoder). In implementations without the LTP, the internal decoder is not needed in the encoder.

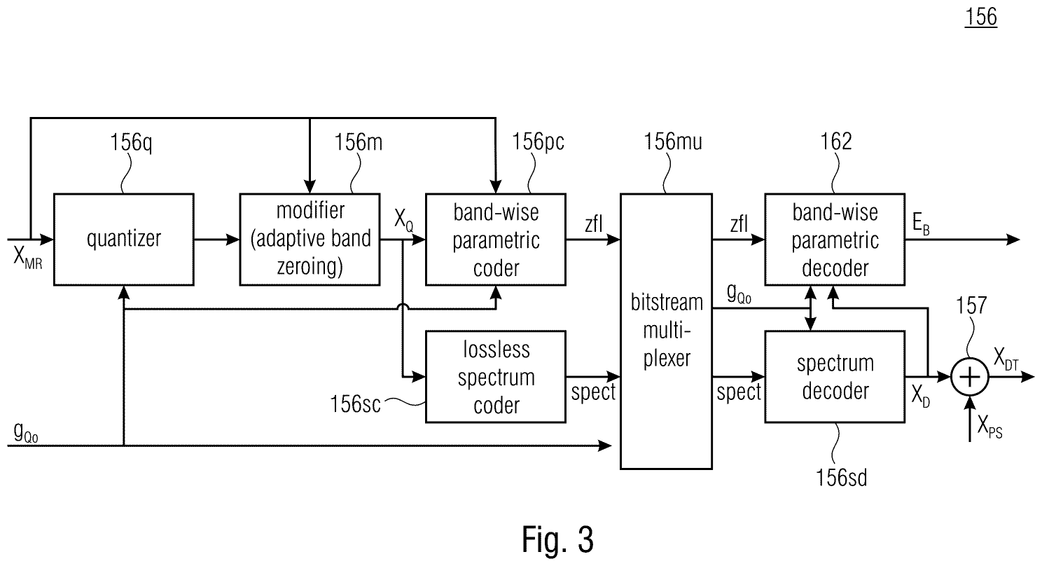

The encoding of the X_{MR} (residual from the LTP) output by the entity 155 is done in the integral band-wise parameter coder (iBPC) as will be discussed with respect to FIG. 3.

Before discussion the entity 155 an excurse to the MDCT 152 of FIG. 2 is given: The output of the MDCT is X_{M} of length L_{M}. For an example at the input sampling rate of 48 kHz and for the example frame length of 20 milliseconds, L_{M} is equal to 960. The codec may operate at other sampling rates and/or at other frame lengths. All other spectra derived from X_{M}: X_{MS}, X_{MT}, X_{MR}, X_{Q}, X_{D}, X_{DT}, X_{CT}, X_{CS}, X_{C}, X_{P}, X_{PS}, X_{N}, X_{NP}, X_{S} are also of the same length L_{M}, though in some cases only a part of the spectrum may be needed and used. A spectrum consists of spectral coefficients, also known as spectral bins or frequency bins. In the case of an MDCT spectrum, the spectral coefficients may have positive and negative values. We can say that each spectral coefficient covers a bandwidth. In the case of 48 kHz sampling rate and the 20 milliseconds frame length, a spectral coefficient covers the bandwidth of 25 Hz. The spectral coefficients may be indexed from 0 to L_{M}−1.

SNS_{E}SNS_{D}N_{SB}=64N_{SB}−1N_{SB}=64 The SNS scale factors, used in and, may be obtained from energies in frequency sub-bands (sometimes also referred to as bands) having increasing bandwidths, where the energies are obtained from a spectrum divided in the frequency sub-bands. For an example, the sub-bands borders, expressed in Hz, may be set to 0, 50, 100, 150, 200, 250, 300, 350, 400, 450, 500, 550, 600, 700, 800, 900, 1000, 1100, 1200, 1300, 1400, 1500, 1600, 1700, 1800, 1900, 2050, 2200, 2350, 2500, 2650, 2800, 2950, 3100, 3300, 3500, 3700, 3900, 4100, 4350, 4600, 4850, 5100, 5400, 5700, 6000, 6300, 6650, 7000, 7350, 7750, 8150, 8600, 9100, 9650, 10250, 10850, 11500, 12150, 12800,13450, 14150, 15000, 16000, 24000. The sub-bands may be indexed from 0 to. In this example the 0^{th} sub-band (from 0 to 50 Hz) contains 2 spectral coefficients, the same as the sub-bands 1 to 11, the sub-band 62 contains 40 spectral coefficients and the sub-band 63 contains 320 coefficients. The energies in frequency sub-bands may be downsampled to 16 values which are coded, the coded values being denoted as “sns”. The 16 decoded values obtained from “sns” are interpolated into SNS scale factors, where may for example be 32, 64 or 128 scale factors. For more details on obtaining the SNS, the reader is referred to [21-25].

In iBPC, “zfl decode” and/or “Zero Filling” blocks, the spectra may be divided into sub-bands Bᵢ of varying length L_{B}_{ᵢ}, the sub-band i starting at j_{B}_{ᵢ}. The same 64 sub-band borders may be used as used for the energies for obtaining the SNS scale factors, but also any other number of sub-bands and any other sub-band borders may be used—independent of the SNS. To stress it out, the same principle of sub-band division as in the SNS may be used, but the sub-band division in iBPC, “zfl decode” and/or “Zero Filling” blocks is independent from the SNS and from SNS_{E} and SNS_{D} blocks. With the above sub-band division example, j_{B}_{₀}=0 and L_{B}_{₀}=2, j_{B}_{₁}=0 and L_{B}_{₁}=2, . . . , j_{B}_{₆₃}=640 and L_{B}_{₆₃}=320.

FIG. 3 shows that the entity iBPC 156 which may have the sub-entities 156q, 156m, 156pc, 156sc and 156mu. At the output of the bit-stream multiplexer 156mu the band-wise parametric decoder (side of L) decoder 162 is arranged together with the spectrum decoder 156sc. Both entities 162 and 156sc are connected to the combiner 157.

At the output of the bit-stream multiplexer 156mu the band-wise parametric decoder 162 is arranged together with the spectrum decoder 156sd. The entity 162 receives the signal zfl, the entity 156sd the signal spect, where both may receive the global gain/step size g_{Q0}. Note the parametric decoder 162 uses the output X_{D} of the spectrum decoder 156sd for decoding zfl. It may alternatively use another signal output from the decoder 156sd. Background there of is that the spectrum decoder 156sd may comprise two parts, namely a spectrum lossless decoder and a dequantizer. For example, the output of the spectrum lossless decoder may be decoded spectrum obtained from spect and used as input for the parametric decoder 162. The output of the spectrum lossless decoder may contain the same information as the input X_{Q} of 156pc and 156sc. The dequantizer may use the global gain/step size to derive X_{D} from the output of the spectrum lossless decoder. The location of zero sub-bands in the decoded spectrum and/or in the dequantized spectrum X_{D} may be determined independent of the quantization step q_{Q}_{₀}.

X_{MR} is quantized and coded including a quantization and coding of an energy for zero values in (a part of) the quantized spectrum X_{Q}, where X_{Q} is a quantized version of X_{MR}. The quantization and coding of X_{MR} is done in the Integral Band-wise Parametric Coder iBPC 156. As one of the parts of the iBPC, the quantization (quantizer 156q) together with the adaptive band zeroing 156m produces, based on the optimal quantization step size q_{Q}_{ₒ}, the quantized spectrum X_{Q}. The iBPC 156 produces coded information consisting of spect 156sc (that represents X_{Q}) and zfl 162 (that may represent the energy for zero values in a part of X_{Q}).

The zero-filling entity 158 arranged at the output of the entity 157 is illustrated by FIG. 4.

FIG. 4 shows a zero-filling entity 158 receiving the signal E_{B} from the entity 162 and combined spectrum X_{DT} from the entity 156sd optionally via the element 157. The zero-filling entity 158 may comprise the two sub-entities 158sc and 158sg as well as a combiner 158c.

The spect is decoded to obtain a dequantized spectrum X_{D} (decoded LTP residual, error spectrum) equivalent to the quantized version of X_{MR} being X_{Q}. E_{B} are obtained from zfl taking into account the location of zero values in X_{D}. E_{B} may be a smoothed version of the energy for zero values in X_{Q}. E_{B} may have a different resolution than zfl, advantageously higher resolution coming from the smoothing. After obtaining E_{B} (cf. 162), the perceptually flattened prediction X_{PS} is optionally added to the decoded X_{D}, producing X_{DT}. A zero filling G is obtained and combined with X_{DT} (for example using addition 158c) in “Zero Filling”, where the zero filling X_{G} consists of a band-wise zero filling [symbol] that is iteratively obtained I from a source spectrum X_{S} consisting of a band-wise source spectrum [symbol] (cf. 156sc) and weighted based on E_{B}. X_{CT} is a band-wise combination of the zero filling X_{S} and the spectrum X_{DT} (158c). X_{S} is band-wise constructed (158sg outputting X_{G}) and X_{CT} is band-wise obtained starting from the lowest sub-band. For each sub-band the source spectrum is chosen (cf. 158sc), for example depending on the sub-band position, the tonality flag (toi), a power spectrum estimated from X_{DT}, E_{B}, pitch information (pii) and temporal information (tei). Note power spectrum estimated from X_{DT} may be derived from X_{DT} or X_{D}. Alternatively a choice of the source spectrum may be obtained from the bit-stream. The lowest sub-bands [symbol] in X_{S} up to a starting frequency f_{ZFStart} may be set to 0, meaning that in the lowest sub-bands X_{CT} may be a copy of X_{DT}. f_{ZFStart} may be 0 meaning that the source spectrum different from zeros may be chosen even from the start of the spectrum. The source spectrum for a sub-band i may for example be a random noise or a predicted spectrum or a combination of the already obtained lower part of X_{CT}, the random noise and the predicted spectrum. The source spectrum X_{S} is weighted based on E_{B} to obtain the zero filling X_{G}.

The weighting, for example, be performed by the entity 158sg and may have higher resolution than the sub-band division; it may be even sample wise determined to obtain a smooth weighting. [symbol] is added to the sub-band i of X_{DT} to produce the sub-band i of X_{CT}.

After obtaining the complete X_{CT}, its temporal envelope is optionally modified via TNS_{D} 159 (cf. FIG. 2a) to match the temporal envelope of X_{MS}, producing X_{CS}. The spectral envelope of X_{CS} is then modified using SNS_{D} 160 to match the spectral envelope of X_{M}, producing X_{C}. A time-domain signal y_{C} is obtained from X_{C}, as output of IMDCT 161 where IMDCT 161 consists of the inverse MDCT, windowing and the Overlap-and-Add. y_{C} is used to update the LTP buffer 164 (either comparable to the buffer 164 in FIGS. 2a and 2c, or to a combination of 164+163) for the following frame. A harmonic post-filter (HPF) that follows pitch contour is applied on y_{c} to reduce noise between harmonics and to output y_{H}. The coded pulses, consisting of coded pulse waveforms, are decoded and a time domain signal y_{P} is constructed from the decoded pulse waveforms. y_{P} is combined with y_{H} to produce the decoded audio signal (PCM_{O}). Alternatively y_{P} may be combined with y_{C} and their combination can be used as the input to the HPF, in which case the output of the HPF 214 is the decoded audio signal.

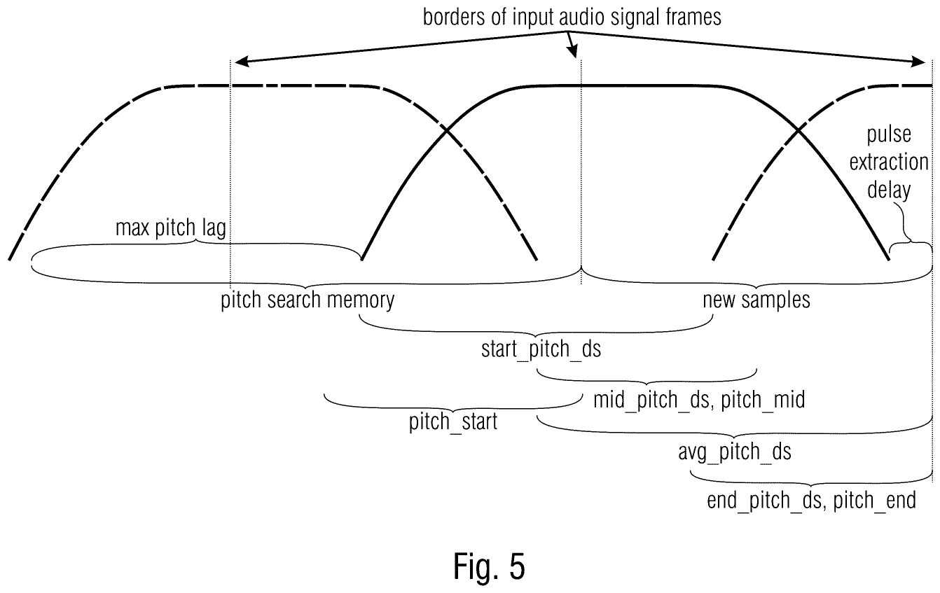

The entity “get pitch contour” 180 is described below taking reference to FIG. 5.

The process in the block “Get pitch contour 180” will be explained now. The input signal is downsampled from the full sampling rate to lower sampling rate, for example to 8 kHz. The pitch contour is determined by pitch_mid and pitch_end from the current frame and by pitch_start that is equal to pitch_end from the previous frame. The frames are exemplarily illustrated by FIG. 5. All values used in the pitch contour are stored as pitch lags with a fractional precision. The pitch lag values are between the minimum pitch lag d_{Fmin}=2.25 milliseconds (corresponding to 444.4 Hz) and the maximum pitch lag d_{Fmin}=19.5 milliseconds (corresponding to 51.3 Hz), the range from d_{Fmin} to d_{Fmax} being named the full pitch range. Other range of values may also be used. The values of pitch_mid and pitch_end are found in multiple steps. In every step, a pitch search is executed in an area of the downsampled signal or in an area of the input signal.

The pitch search calculates normalized autocorrelation ρ_{H}[d_{F}] of its input and a delayed version of the input. The lags d_{F} are between a pitch search start d_{Fstart} and a pitch search end d_{Fend}. The pitch search start d_{Fstart}, the pitch search end d_{Fend}, the autocorrelation length l_{ρH} and a past pitch candidate d_{Fpast} are parameters of the pitch search. The pitch search returns an optimum pitch d_{Foptim}, as a pitch lag with a fractional precision, and a harmonicity level ρ_{Hoptim}, obtained from the autocorrelation value at the optimum pitch lag. The range of ρ_{Hoptim} is between 0 and 1, 0 meaning no harmonicity and 1 maximum harmonicity.

The location of the absolute maximum in the normalized autocorrelation is a first candidate d_{F1} for the optimum pitch lag. If d_{Fpast} is near d_{F1} then a second candidate d_{F2} for the optimum pitch lag is d_{Fpast}, otherwise the location of the local maximum near d_{Fpast} is the second candidate d_{F2}. The local maximum is not searched if d_{Fpast} is near d_{F1}, because then d_{F1} would be chosen again for d_{F2}. If the difference of the normalized autocorrelation at d_{F1} and d_{F2} is above a pitch candidate threshold τ_{dF}, then d_{Foptim} is set to d_{F1} (ρ_{H}[d_{F1}]−ρ_{H}[d_{F2}]>τ_{dF}⇒d_{Foptim}=d_{F1}), otherwise d_{Foptim} is set to d_{F2}. τ_{dF} is adaptively chosen depending on d_{F1}, d_{F2} and d_{Fpast}, for example τ_{dF}=0.01 if 0.75·d_{F1}≤d_{Fpast}≤1.25·d_{F1} otherwise τ_{dF}=0.02 if d_{F1}≤d_{F2} and τ_{dF}=0.03 if d_{F1}>d_{F2} (for a small pitch change it is easier to switch to the new maximum location and if the change is big then it is easier to switch to a smaller pitch lag than to a larger pitch lag).

Locations of the areas for the pitch search in relation to the framing and windowing are shown in FIG. 5. For each area the pitch search is executed with the autocorrelation length l_{ρH} set to the length of the area. First, the pitch lag start_pitch_ds and the associated harmonicity start_norm_corr_ds is calculated at the lower sampling rate using d_{Fpast}=pitch_start, d_{Fstart}=d_{Fmin} and d_{Fend}=d_{Fmax} in the execution of the pitch search. Then, the pitch lag avg_pitch_ds and the associated harmonicity avg_norm_corr_ds is calculated at the lower sampling rate using d_{Fpast}=start_pitch_ds, d_{Fstart}=d_{Fmin} and d_{Fend}=d_{Fmax} in the execution of the pitch search. The average harmonicity in the current frame is set to max(start_norm_corr_ds,avg_norm_corr_ds). The pitch lags mid_pitch_ds and end_pitch_ds and the associated harmonicities mid_norm_corr_ds and end_norm_corr_ds are calculated at the lower sampling rate using d_{Fpast}=avg_pitch_ds, d_{Fstart}=0.3·avg_pitch_ds and d_{Fend}=0.7·avg_pitch_ds in the execution of the pitch search. The pitch lags pitch_mid and pitch_end and the associated harmonicities norm_corr_mid and norm_corr_end are calculated at the full sampling rate using d_{Fpast}=pitch_ds, d_{Fstart}=pitch_ds−Δ_{Fdown} and d_{Fend}=pitch_ds+α_{Fdown} in the execution of the pitch search, where Δ_{Fdown} is the ratio of the full and the lower sampling rate and pitch_ds=mid_pitch_ds for pitch_mid and pitch_ds=end_pitch_ds for pitch_end.

If the average harmonicity is below 0.3 or if norm_corr end is below 0.3 or if norm_corr_mid is below 0.6 then it is signaled in the bit-stream with a single bit that there is no pitch contour in the current frame. If the average harmonicity is above 0.3 the pitch contour is coded using absolute coding for pitch_end and differential coding for pitch_mid. Pitch_mid is coded differentially to (pitch_start+pitch_end)/2 using 3 bits, by using the code for the difference to (pitch_start+pitch_end)/2 among 8 predefined values, that minimizes the autocorrelation in the pitch_mid area. If there is an end of harmonicity in a frame, e.g. norm_corr_end<norm_corr_mid/2, then linear extrapolation from pitch_start and pitch_mid is used for pitch_end, so that pitch_mid may be coded (e.g. norm_corr_mid>0.6 and norm_corr_end<0.3).

If |pitch_mid-pitch start|≤τ_{HPFconst} and |norm_corr_mid-norm_corr_start|≤0.5 and the expected HPF gains in the area of the pitch_start and pitch_mid are close to 1 and don't change much then it is signaled in the bit-stream that the HPF should use constant parameters.

The pitch contour provides d_{contour} a pitch lag value d_{contour}[i] at every sample i in the current window and in at least d_{Fmax} past samples. The pitch lags of the pitch contour are obtained by linear interpolation of pitch_mid and pitch_end from the current, previous and second previous frame.

An average pitch lag d̅_{F}_{₀} is calculated for each frame as an average of pitch_start, pitch_mid and pitch_end.

A half pitch lag correction is according to further embodiments also possible.

The LTP buffer, which is available in both the encoder and the decoder, is used to check if the pitch lag of the input signal is below d_{Fmin}. The detection if the pitch lag of the input signal is below d_{Fmin} is called “half pitch lag detection” and if it is detected it is said that “half pitch lag is detected”. The coded pitch lag values (pitch_mid, pitch_end) are coded and transmitted in the range from d_{Fmin} to d_{Fmax}. From these coded parameters the pitch contour is derived as defined above. If half pitch lag is detected, it is expected that the coded pitch lag values will have a value close to an integer multiple n_{Fcorrection} of the true pitch lag values (equivalently the input signal pitch is near an integer multiple n_{Fcorrection} of the coded pitch). To extended the pitch lag range beyond the codable range, corrected pitch lag values (pitch_mid_corrected, pitch_end_corrected) are used. The corrected pitch lag values (pitch_mid_corrected, pitch_end_corrected) may be equal to the coded pitch lag values (pitch_mid, pitch_end) if the true pitch lag values are in the codable range. Note the corrected pitch lag values may be used to obtain the corrected pitch contour in the same way as the pitch contour is derived from the pitch lag values. In other words, this enables to extend the frequency range of the pitch contour outside of the frequency range for the coded pitch parameters, producing a corrected pitch contour.

The half pitch detection is run only if the pitch is considered constant in the current window and d̅_{F}_{₀}<n_{Fcorrection}·d_{Fmin}. The pitch is considered constant in the current window if max(|pitch_mid-pitch_start|, |pitch_mid-pitch_end|)<τ_{Fconst}. In the half pitch detection, for each n_{Fmultiple}∈{1, 2, . . . , n_{Fmaxcorrection}} pitch search is executed using l_{ρH}=d̅_{F}_{₀}, d_{Fpast}=d̅_{F}_{₀}/n_{Fmultiple}, d_{Fstart}=d_{Fpast}−3 and d_{Fend}=d_{Fpart}+3. n_{Fcorrection} is set to n_{Fmultiple} that maximizes the normalized correlation returned by the pitch search. It is considered that the half pitch is detected if n_{Fcorrection}>1 and the normalized correlation returned by the pitch search for n_{Fcorrection} is above 0.8 and 0.02 above the normalized correlation return by the pitch search for n_{Fmultiple}=1.

If half pitch lag is detected then pitch_mid_corrected and pitch_end_corrected take the value returned by the pitch search for n_{Fmultiple}=n_{Fcorrection}, otherwise pitch_mid_corrected and pitch_end_corrected are set to pitch_mid and pitch_end respectively.

An average corrected pitch lag d̅_{F}_{_{corrected}} is calculated as an average of pitch_start, pitch_mid_corrected and pitch_end_corrected after correcting eventual octave jumps. The octave jump correction finds minimum among pitch_start, pitch_mid_corrected and pitch_end_corrected and for each pitch among pitch_start, pitch_mid_corrected and pitch_end_corrected finds pitch/n_{Fmultiple} closest to the minimum (for n_{Fmultiple}∈{1, 2, . . . , n_{Fmaxcorrection}}). The pitch/n_{Fmultiple} is then used instead of the original value in the calculation of the average.

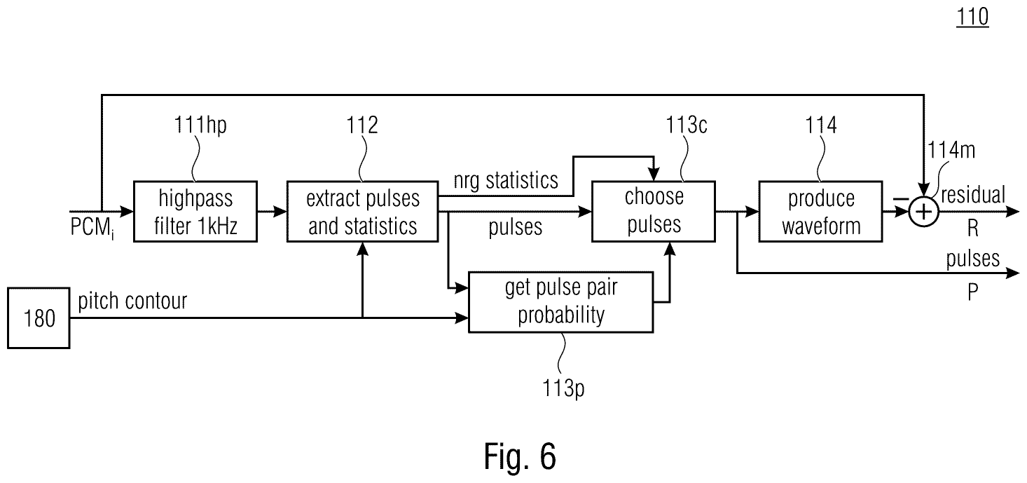

Below the pulse extraction may be discussed in context of FIG. 6. FIG. 6 shows the pulse extractor 110 having the entities 111hp, 112, 113c, 113p, 114 and 114m. The first entity at the input is an optional high pass filter 111hp which outputs the signal to the pulse extractor 112 (extract pulses and statistics).

At the output two entities 113c and 113p are arranged, which interact together and receive as input the pitch contour from the entity 180. The entity for choosing the pulses 113c outputs the pulses P directly into another entity 114 producing a waveform. This is the waveform of the pulse and can be subtracted using the mixer 114m from the PCM, signal so as to generate the residual signal R (residual after extracting the pulses).

Up to 8 pulses per frame are extracted and coded. In another example other number of maximum pulses may be used. N_{P}_{_{P}} pulses from the previous frames are kept and used in the extraction and predictive coding (0≤N_{P}_{_{P}}≤3). In another example other limit may be used for N_{P}_{_{P}}. The “Get pitch contour 180” provides d̅_{F}_{₀}; alternatively, d̅_{F}_{_{corrected}} may be used. It is expected that d̅_{F}_{₀} is zero for frames with low harmonicity.

Time-frequency analysis via Short-time Fourier Transform (STFT) is used for finding and extracting pulses (cf. entity 112). In another example other time-frequency representations may be used. The signal PCM_{I} may be high-passed (111hp) and windowed using 2 milliseconds long squared sine windows with 75% overlap and transformed via Discrete Fourier Transform (DFT) into the Frequency Domain (FD). The filter 111hp is configured to filter the audio signal PCM_{I} so that each pulse waveform of the pulse portion comprises a high-pass characteristic (after further processing, e.g. after pulse extraction) and/or a characteristic having more energy at frequencies starting above a start frequency and so that the high-pass characteristic in the residual signal is removed or reduced . Alternatively, the high pass filtering may be done in the FD (in 112s or at the output of 112s). Thus in each frame of 20 milliseconds there are 40 points for each frequency band, each point consisting of a magnitude and a phase. Each frequency band is 500 Hz wide and we are considering only 49 bands for the sampling rate F_{S}=48 kHz, because the remaining 47 bands may be constructed via symmetric extension. Thus there are 49 points in each time instance of the STFT and 40·49 points in the time-frequency plane of a frame. The STFT hop size is H_{P}=0.0005 F_{S}.

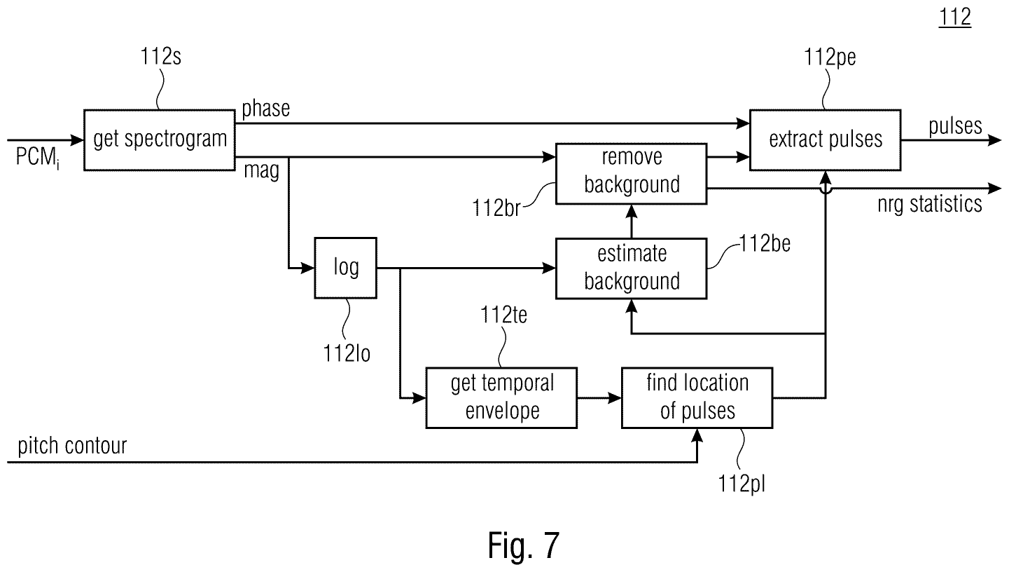

In FIG. 7 the entity 112 is shown in more details. In 112te a temporal envelope is obtained from the log magnitude spectrogram by integration across the frequency axis, that is for each time instance of the STFT log magnitudes are summed up to obtain one sample of the temporal envelope.

The shown entity 112 comprises a Get spectrogram entity 112s outputting the phase and/or the magnitude spectrogram based on the PCM, signal. The phase spectrogram is forwarded to the pulse extractor 112pe, while the magnitude spectrogram is further processed. The magnitude spectrogram may be processed using a background remover 112br, a background estimator 112be for estimating the background signal to be removed. Additionally or alternatively a temporal envelope determiner 112te and a pulse locator 112pl processes the magnitude spectrogram. The entities 112pl and 112te enable to determine pulse location(s) which are used as input for the pulse extractor 112pe and the background estimator 112be. The pulse locator finder 112pl may use a pitch contour information. Optionally, some entities, for example, the entity 112be and the entity 112te may use logarithmic representation of the magnitude spectrogram obtained by the entity 112lo.

According to embodiments, the pulse coder 112pe may be configured to process an enhanced spectrogram, wherein the enhanced spectrogram is derived from the spectrogram of the audio signal, or the pulse portion P so that each pulse waveform of the pulse portion P comprises a high-pass characteristic and/or a characteristic having more energy at frequencies starting above a start frequency, where the start frequency being proportional to the inverse of an average distance between nearby pulse waveforms. The start frequency proportional to the average distance is available after finding the location of the pulses (cf. 112pl). Note the pulse location is equivalent to the pulse position.

Below the functionality will be discussed. Smoothed temporal envelope is low-pass filtered version of the temporal envelope using short symmetrical FIR filter (for an example 4^{th} order filter at F_{S}=48 kHz).

Normalized autocorrelation of the temporal envelope is calculated:

$$\\ {ρ}_{{e}_{T}} [ m ] = \frac{{\sum }_{n = 0}^{40} {e}_{T} [ n ] {e}_{T} [ n - m ]}{\sqrt{( {\sum }_{n = 0}^{40} {e}_{T} [ n ] {e}_{T} [ n ] ) ( {\sum }_{n = - m}^{40 - m} {e}_{T} [ n ] {e}_{T} [ n ] )}}$$

$$\\ {\hat{ρ}}_{{e}_{T}} = \{ \begin{matrix}{max}_{5 \leq m \leq 12} {ρ}_{{e}_{T}} [ m ] , & {max}_{5 \leq m \leq 12} {ρ}_{{e}_{T}} [ m ] > 0.65 \\ 0 , & {max}_{5 \leq m \leq 12} {ρ}_{{e}_{T}} [ m ] \leq 0.65\end{matrix}$$

where e_{T} is the temporal envelope after mean removal. The exact delay for the maximum ( [symbol] ) is estimated using Lagrange polynomial of 3 points forming the peak in the normalized autocorrelation.

Expected average pulse distance may be estimated from the normalized autocorrelation of the temporal envelope and the average pitch lag in the frame:

$$\\ {\tilde{D}}_{P} = \{ \begin{matrix}{D}_{{ρ}_{{e}_{T}}} , & {\hat{ρ}}_{{e}_{T}} > 0 \\ min ( \frac{{\overline{d}}_{{F}_{0}}}{{H}_{P}} , 13 ) , & {\hat{ρ}}_{{e}_{T}} = 0 ⋀ {\overline{d}}_{{F}_{0}} > 0 \\ 13 , & {\hat{ρ}}_{{e}_{T}} = 0 ⋀ {\overline{d}}_{{F}_{0}} = 0\end{matrix}$$

where for the frames with low harmonicity, \tilde{D}_{P} is set to 13, which corresponds to 6.5 milliseconds.

Positions of the pulses are local peaks in the smoothed temporal envelope with the requirement that the peaks are above their surroundings. The surrounding is defined as the low-pass filtered version of the temporal envelope using simple moving average filter with adaptive length; the length of the filter is set to the half of the expected average pulse distance (\tilde{D}_{P}). The exact pulse position (\dot{t}_{P}_{ᵢ}) is estimated using Lagrange polynomial of 3 points forming the peak in the smoothed temporal envelope. The pulse center position (t_{P}_{ᵢ}) is the exact position rounded to the STFT time instances and thus the distance between the center positions of pulses is a multiple of 0.5 milliseconds. It is considered that each pulse extends 2 time instances to the left and 2 to the right from its temporal center position. Other number of time instances may also be used.

Up to 8 pulses per 20 milliseconds are found; if more pulses are detected then smaller pulses are disregarded. The number of found pulses is denoted as N_{P}_{_{X}}. i^{th} pulse is denoted as Pᵢ. The average pulse distance is defined as:

$$\\ {\overline{D}}_{P} = \{ \begin{matrix}{\tilde{D}}_{P} , & {\hat{ρ}}_{{e}_{T}} > 0 ⋁ {\overline{d}}_{{F}_{0}} > 0 \\ min ( \frac{40}{{N}_{{P}_{X}}} , 13 ) , & {\hat{ρ}}_{{e}_{T}} = 0 ⋀ {\overline{d}}_{{F}_{0}} = 0\end{matrix}$$

Magnitudes are enhanced based on the pulse positions so that the enhanced STFT, also called enhanced spectrogram, consists only of the pulses. The background of a pulse is estimated as the linear interpolation of the left and the right background, where the left and the right backgrounds are mean of the 3^{rd} to 5^{th} time instance away from the temporal center position. The background is estimated in the log magnitude domain in 112be and removed by subtracting it in the linear magnitude domain in 112br. Magnitudes in the enhanced STFT are in the linear scale. The phase is not modified. All magnitudes in the time instances not belonging to a pulse are set to zero.

The start frequency of a pulse is proportional to the inverse of the average pulse distance (between nearby pulse waveforms) in the frame, but limited between 750 Hz and 7250 Hz:

$$\\ {f}_{{P}_{i}} = min ( ⌊ 2 {( \frac{13}{{\overline{D}}_{P}} )}^{2} + 0.5 ⌋ , 15 )$$

The start frequency (f_{P}_{ᵢ}) is expressed as index of an STFT band.

In general according to embodiments, said spacing may vary from pulse to pulse, so that an average can be formed. This average spacing/average distance between pulses may be for example estimated as the average pulse distance D̅_{P}. This average spacing/average distance estimation is used for calculating the start frequency f_{P}_{ᵢ} as explained.

The change of the starting frequency in consecutive pulses is limited to 500 Hz (one STFT band). Magnitudes of the enhanced STFT bellow the starting frequency are set to zero in 112pe.

Waveform of each pulse is obtained from the enhanced SIFT in 112pe. The pulse waveform is non-zero in 4 milliseconds around its temporal center and the pulse length is L_{W}_{_{P}}=0.004 F_{S} (the sampling rate of the pulse waveform is equal to the sampling rate of the input signal F_{S}). The symbol x_{P}_{ᵢ} represents the pulse waveform of the i^{th} pulse.

Each pulse Pᵢ is uniquely determined by the center position t_{P}_{ᵢ} and the pulse waveform x_{P}_{ᵢ}. The pulse extractor 112pe outputs pulses Pᵢ consisting of the center positions t_{P}_{ᵢ} and the pulse waveforms x_{P}_{ᵢ}. The pulses are aligned to the STFT grid. Alternatively, the pulses may be not aligned to the STFT grid and/or the exact pulse position (\dot{t}_{P}_{ᵢ}) may determine the pulse instead of t_{P}_{ᵢ}.

Features are calculated for each pulse:
percentage of the local energy in the pulse—p_{E}_{_{L}}_{,P}_{ᵢ}
percentage of the frame energy in the pulse—p_{E}_{_{F}}_{,P}_{ᵢ}
percentage of bands with the pulse energy above the half of the local energy—p_{N}_{_{E}}_{,P}_{ᵢ}
correlation ρ_{P}_{ᵢ}_{,P}_{ⱼ} and distance d_{P}_{ᵢ}_{,P}_{ⱼ} between each pulse pair (among the pulses in the current frame and the N_{P}_{_{P}} last coded pulses from the past frames)
pitch lag at the exact location of the pulse—d_{P}_{ᵢ}

The local energy is calculated from the 11 time instances around the pulse center in the original STFT. All energies are calculated only above the start frequency.

The distance between a pulse pair d_{P}_{ⱼ}_{,P}_{ᵢ} is obtained from the location of the maximum cross-correlation between pulses (x_{P}_{ᵢ}*x_{P}_{ⱼ}) [m]. The cross-correlation is windowed with the 2 milliseconds long rectangular window and normalized by the norm of the pulses (also windowed with the 2 milliseconds rectangular window). The pulse correlation is the maximum of the normalized cross-correlation:

$$\\ ( {x}_{{P}_{i}} * {x}_{{P}_{j}} ) [ m ] = \frac{{\sum }_{n = l}^{{L}_{{W}_{P}} - l} {x}_{{P}_{i}} [ n ] {x}_{{P}_{j}} [ n + m ]}{\sqrt{( {\sum }_{n = l}^{{L}_{{W}_{P}} - l} {x}_{{P}_{i}} [ n ] {x}_{{P}_{i}} [ n ] ) ( {\sum }_{n = l}^{{L}_{{W}_{P}} - l} {x}_{{P}_{j}} [ n + m ] {x}_{{P}_{j}} [ n + m ] )}}$$

$$\\ {ρ}_{{P}_{j} , {P}_{i}} = \{ \begin{matrix}{max}_{- l \leq m \leq l} ( {x}_{{P}_{i}} * {x}_{{P}_{j}} ) [ m ] , i < j \\ {max}_{- l \leq m \leq l} ( {x}_{{P}_{j}} * {x}_{{P}_{i}} ) [ m ] , i > j \\ 0 , i = j\end{matrix}$$

$$\\ {Δ}_{{ρ}_{{P}_{j} , {P}_{i}}} = \{ \begin{matrix}{arg max}_{- l \leq m \leq l} ( {x}_{{P}_{i}} * {x}_{{P}_{j}} ) [ m ] , i < j \\ {- arg max}_{- l \leq m \leq l} ( {x}_{{P}_{j}} * {x}_{{P}_{i}} ) [ m ] , i > j \\ 0 , i = j\end{matrix}$$

$$\\ {d}_{{P}_{j} , {P}_{i}} = \vert {t}_{{P}_{j}} - {t}_{{P}_{i}} + {Δ}_{{ρ}_{{P}_{j} , {P}_{i}}} \vert = \vert {t}_{{P}_{i}} - {t}_{{P}_{j}} + {Δ}_{{ρ}_{{P}_{i} , {P}_{j}}} \vert$$

$$\\ l = \frac{{L}_{{W}_{P}}}{4}$$

The value of (x_{P}_{ᵢ}*x_{P}_{ⱼ}) [m] is in the range between 0 and 1.

Error between the pitch and the pulse distance is calculated as:

$$\\ {ϵ}_{{P}_{i} , {P}_{j}} = {ϵ}_{{P}_{j} , {P}_{i}} = min ( {min}_{1 \leq k \leq 6} \frac{\vert k \cdot {d}_{{P}_{j} , {P}_{i}} - {d}_{{P}_{j}} \vert}{{H}_{P}} , {min}_{1 \leq k \leq j - i} \frac{\vert {d}_{{P}_{j} , {P}_{i}} - k \cdot {d}_{{P}_{j}} \vert}{{H}_{P}} ) , i < j$$

Introducing multiple of the pulse distance (k·d_{P}_{ⱼ}_{,P}_{ᵢ}), errors in the pitch estimation are taken into account. Introducing multiples of the pitch lag (k·d_{P}_{ⱼ}) solves missed pulses coming from imperfections in pulse trains: if a pulse in the train is distorted or there is a transient not belonging to the pulse train that inhibits detection of a pulse belonging to the train. Probability that the i^{th} and the j^{th} pulse belong to a train of pulses (cf. entity 113p):

$${p}_{{P}_{i} , {P}_{j}} = {p}_{{P}_{j} , {P}_{i}} = \{ \begin{matrix}min ( 1 , \frac{{ρ}_{{P}_{j} , {P}_{i}^{2}}}{\sqrt[10]{max ( 0.2 , {ϵ}_{{P}_{i} , {P}_{j}} )}} ) , & - {N}_{{P}_{P}} \leq j < 0 \leq i < {N}_{{P}_{X}} \\ min ( 1 , \frac{{ρ}_{{P}_{j} , {P}_{i}}}{2 \cdot \sqrt{max ( 0.1 , {ϵ}_{{P}_{i} , {P}_{j}} )}} ) , & 0 \leq i < j < {N}_{{P}_{X}}\end{matrix}$$

Probability of a pulse with the relation only to the already coded past pulses (cf. entity 113p) is defined as:

$${\dot{p}}_{{P}_{i}} = {p}_{{E}_{F} , {P}_{i}} ( 1 + {max}_{- {N}_{{P}_{P}} \leq j < 0} {p}_{{P}_{j} , {P}_{i}} )$$

Probability (cf. entity 113c) of a pulse (p_{P}_{ᵢ}) is iteratively found:
1. All pulse probabilities (p_{P}_{ᵢ}, 0≤i<N_{P}_{_{X}}) are set to 1
2. In the time appearance order of pulses, for each pulse that is still probable (p_{P}_{ᵢ}>0):
   a. Probability of the pulse belonging to a train of the pulses in the current frame is calculated:

$${{p}^{...}}_{{P}_{i}} = {p}_{{E}_{F} , {P}_{i}} ( {\sum }_{j = 0}^{i - 1} {p}_{{P}_{j}} \cdot {p}_{{P}_{j} , {P}_{i}} + {\sum }_{j = i + 1}^{{N}_{{P}_{X}^{- 1}}} {p}_{{P}_{j}} \cdot {p}_{{P}_{j} , {P}_{i}} )$$

b. The initial probability that it is truly a pulse is then:

p_{P}_{ᵢ}=\dot{p}_{P}_{ᵢ}+ [symbol]
c. The probability is increased for pulses with the energy in many bands above the half of the local energy:

p_{P}_{ᵢ}=max(p_{P}_{ᵢ},min(p_{N}_{_{E}}_{,P}_{ᵢ},1.5·p_{P}_{ᵢ}))
d. The probability is limited by the temporal envelope correlation and the percentage of the local energy in the pulse:

p_{P}_{ᵢ}=min(p_{P}_{ᵢ},(1+0.4·\hat{ρ}ₑ_{_{T}})p_{E}_{_{L}}_{,P}_{ᵢ})
e. If the pulse probability is below a threshold, then its probability is set to zero and it is not considered anymore:

$${p}_{{P}_{i}} = \{ \begin{matrix}1 , & {p}_{{P}_{i}} \geq 0.15 \\ 0 , & {p}_{{P}_{i}} < 0.15\end{matrix}$$

3. The step 2 is repeated as long as there is at least one p_{P}_{ᵢ} set to zero in the current iteration or until all p_{P}_{ᵢ} are set to zero.

At the end of this procedure, there are N_{P}_{_{c}} true pulses with p_{P}_{ᵢ} equal to one. All and only true pulses constitute the pulse portion P and are coded as CP. Among the true N_{P}_{_{c}} pulses up to three last pulses are kept in memory for calculating ρ_{P}_{ᵢ}_{,P}_{ⱼ} and d_{P}_{ᵢ}_{,P}_{ⱼ} in the following frames. If there are less than three true pulses in the current frame, some pulses already in memory are kept. In total up to three pulses are kept in the memory. There may be other limit for the number of pulses kept in memory, for example 2 or 4. After there are three pulses in the memory, the memory remains full with the oldest pulses in memory being replaced by newly found pulses. In other words, the number of past pulses N_{P}_{_{P}} kept in memory is increased at the beginning of processing until N_{P}_{_{P}}=3 and is kept at 3 afterwards.

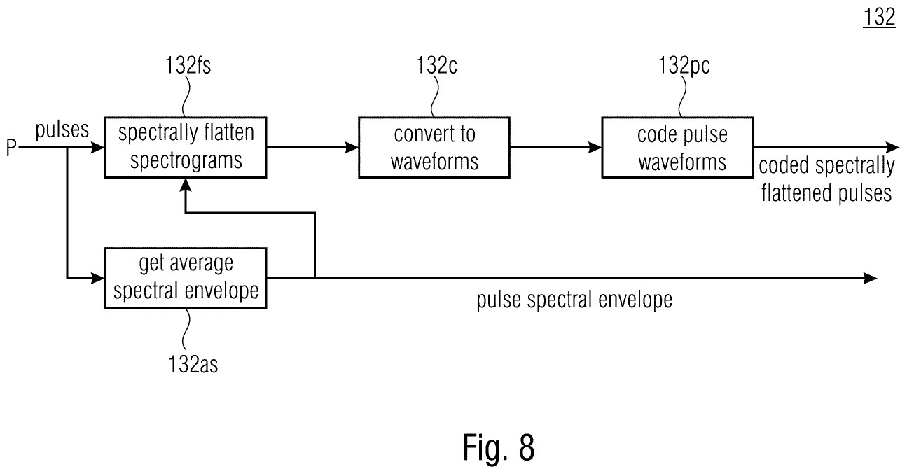

Below, with respect to FIG. 8 the pulse coding (encoder side, cf. entity 132 of FIG. 1a) will be discussed.

FIG. 8 shows the pulse coder 132 comprising the entities 132fs, 132c and 132pc in the main path, wherein the entity 132as is arranged for determining and providing a pulse spectral envelope as input to the entity 132fs configured for performing spectrally flattening. Within the main path 132fs, 132c and 132pc, the pulses P are coded to determine coded spectrally flattened pulses. The coding performed by the entity 132pc is performed on spectrally flattened pulses. The coded pulses CP in FIG. 2a-c consists of the coded spectrally flattened pulses and the pulse spectral envelope. The coding of the plurality of pulses will be discussed in detail with respect to FIG. 10.

Pulses are coded using parameters:
number of pulses in the frame N_{P}_{_{c}}
position within the frame t_{P}_{ᵢ}
pulse starting frequency f_{P}_{ᵢ}
pulse spectral envelope
prediction gain [symbol] and if [symbol] is not zero:
   index of the prediction source [symbol]
   prediction offset [symbol]
   innovation gain [symbol]
innovation consisting of up to 4 impulses, each pulse coded by its position and sign

A single coded pulse is determined by parameters:
pulse starting frequency f_{P}_{ᵢ}
pulse spectral envelope
prediction gain [symbol] and if [symbol] is not zero:
   index of the prediction source [symbol]
   prediction offset [symbol]
innovation gain [symbol]
innovation consisting of up to 4 impulses, each pulse coded by its position and sign From the parameters that determine the single coded pulse a waveform can be constructed that present the single coded pulse. We can then also say that the coded pulse waveform is determined by the parameters of the single coded pulse.

The number of pulses is Huffman coded.

The first pulse position t_{P}_{₀} is coded absolutely using Huffman coding. For the following pulses the position deltas Δ_{P}_{ᵢ}=t_{P}_{ᵢ}−t_{P}_{_{i−1}} are Huffman coded. There are different Huffman codes depending on the number of pulses in the frame and depending on the first pulse position.

The first pulse starting frequency f_{P}_{₀} is coded absolutely using Huffman coding. The start frequencies of the following pulses is differentially coded. If there is a zero difference then all the following differences are also zero, thus the number of non-zero differences is coded. All the differences have the same sign, thus the sign of the differences can be coded with single bit per frame. In most cases the absolute difference is at most one, thus single bit is used for coding if the maximum absolute difference is one or bigger. At the end, only if maximum absolute difference is bigger than one, all non-zero absolute differences need to be coded and they are unary coded.

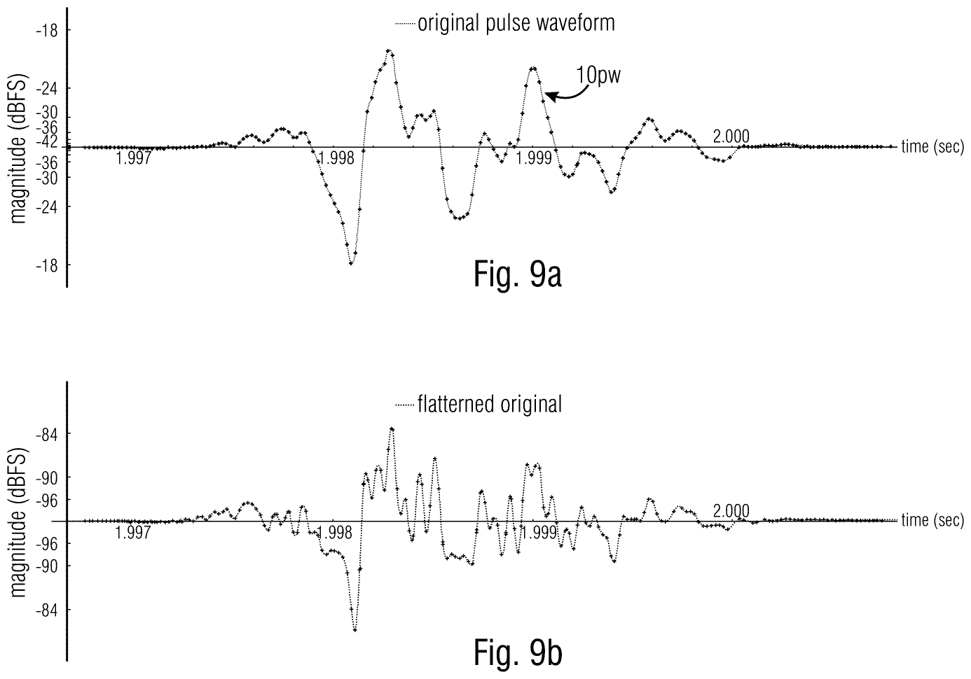

The spectral flattening, e.g. performed using an STFT (cf. entity 132fs of FIG. 8) is illustrated by FIGS. 9a and 9b, where FIG. 9a shows the original pulse waveform 10pw in comparison to the flattened version of FIG. 9b. Note the spectral flattening may alternatively be performed by a filter, e.g. in the time domain. Additionally it is shown in FIG. 9 that a pulse is determined by the pulse waveform, e.g. the original pulse is determined by the original pulse waveform and the flattened pulse is determined by the flattened pulse waveform. The original pulse waveform (10pw) may be obtained from the enhanced STFT (10p′) via inverse DFT, window and overlap-and-add, in the same manner as the spectrally flattened pulse waveform (FIG. 9b) is obtained from the spectrally flattened SIFT in 132c.

All pulses in the frame may use the same spectral envelope (cf. entity 132as) consisting for an example of eight bands. Band border frequencies are: 1 kHz, 1.5 kHz, 2.5 kHz, 3.5 kHz, 4.5 kHz, 6 kHz, 8.5 kHz, 11.5 kHz, 16 kHz. Spectral content above 16 kHz is not explicitly coded. In another example other band borders may be used.

Spectral envelope in each time instance of a pulse is obtained by summing up the magnitudes within the envelope bands, the pulse consisting of 5 time instances. The envelopes are averaged across all pulses in the frame. Points between the pulses in the time-frequency plane are not taken into account.

The values are compressed using fourth root and the envelopes are vector quantized. The vector quantizer has 2 stages and the 2^{nd} stage is split in 2 halves. Different codebooks exist for frames with d̅_{F}_{₀}=0 and d̅_{F}_{₀}≠0 and for the values of N_{P}_{_{C}} and f_{P}_{ᵢ}. Different codebooks need different number of bits.

The quantized envelope may be smoothed using linear interpolation. The spectrograms of the pulses are flattened using the smoothed envelope (cf. entity 132fs). The flattening is achieved by division of the magnitudes with the envelope (received from the entity 132as), which is equivalent to subtraction in the logarithmic magnitude domain. Phase values are not changed. Alternatively, a filter processor may be configured to spectrally flatten the pulse waveform by filtering the pulse waveform in time domain.

Waveform of the spectrally flattened pulse y_{P}_{ᵢ} is obtained from the STFT via the inverse DFT, windowing and overlap and add in 132c.

FIG. 10 shows an entity 132pc for coding a single spectrally flattened pulse waveform of the plurality of spectrally flattened pulse waveforms. Each single coded pulse waveform is output as coded pulse signal. From another point of view, the entity 132pc for coding single pulses of FIG. 10 is than the same as the entity 132pc configured for coding pulse waveforms as shown in FIG. 8, but used several times for coding the several pulse waveforms.

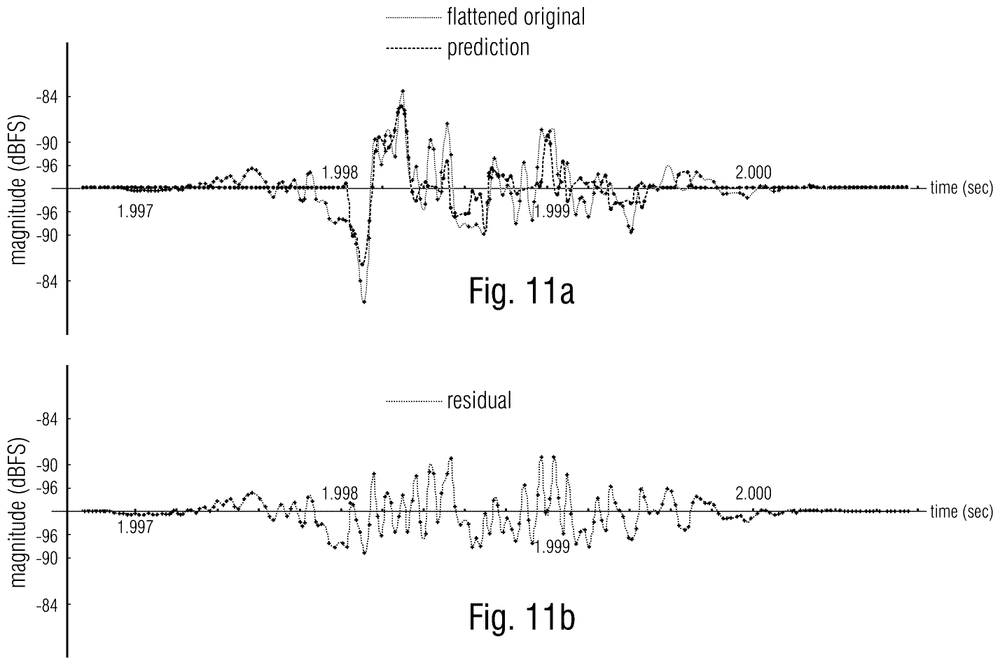

The entity 132pc of FIG. 10 comprises a pulse coder 132spc, a constructor for the flattened pulse waveform 132cpw and the memory 132m arranged as kind of a feedback loop. The constructor 132cpw has the same functionality as 220cpw and the memory 132m the same functionality as 229 in FIG. 14. Each single/current pulse is coded by the entity 132spc based on the flattened pulse waveform taking into account past pulses. The information on the past pulses is provided by the memory 132m. Note the past pulses coded by 132pc are fed via the pulse waveform constructer 132cpw and memory 132m. This enables the prediction. The result by using such prediction approach is illustrated by FIG. 11. Here FIG. 11a, indicates the flattened original together with the prediction and the resulting prediction residual signal in FIG. 11b.

According to embodiments the most similar previously quantized pulse is found among N_{P}_{_{P}} pulses from the previous frames and already quantized pulses from the current frame. The correlation ρ_{P}_{ᵢ}_{,P}_{ⱼ}, as defined above, is used for choosing the most similar pulse. If differences in the correlation are below 0.05, the closer pulse is chosen. The most similar previous pulse is the source of the prediction \tilde{z}_{P}_{ᵢ} and its index [symbol] , relative to the currently coded pulse, is used in the pulse coding. Up to four relative prediction source indexes [symbol] are grouped and Huffman coded. The grouping and the Huffman codes are dependent on N_{P}_{_{C}} and whether d̅_{F}_{₀}=0 or d̅_{F}_{₀}≠0.

The offset for the maximum correlation is the pulse prediction offset [symbol] . It is coded absolutely, differentially or relatively to an estimated value, where the estimation is calculated from the pitch lag at the exact location of the pulse d_{P}_{ᵢ}. The number of bits needed for each type of coding is calculated and the one with minimum bits is chosen.

Gain [symbol] that maximizes the SNR is used for scaling the prediction \tilde{z}_{P}_{ᵢ}. The prediction gain is non-uniformly quantized with 3 to 4 bits. If the energy of the prediction residual is not at least 5% smaller than the energy of the pulse, the prediction is not used and [symbol] is set to zero.

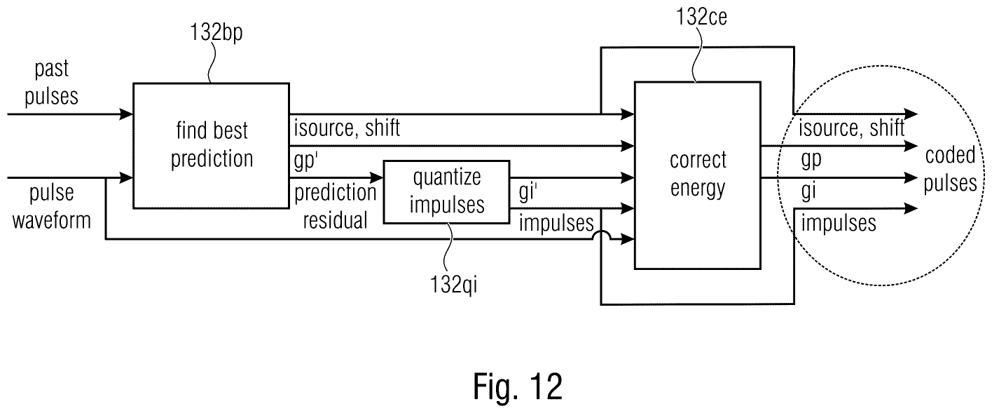

The prediction residual is quantized using up to four impulses. In another example other maximum number of impulses may be used. The quantized residual consisting of impulses is named innovation ż_{P}_{ᵢ}. This is illustrated by FIG. 12. To save bits, the number of impulses is reduced by one for each pulse predicted from a pulse in this frame. In other words: if the prediction gain is zero or if the source of the prediction is a pulse from previous frames then four impulses are quantized, otherwise the number of impulses decreases compared to the prediction source.

FIG. 12 shows a processing path to be used as process block 132spc of FIG. 10. The process path enables to determine the coded pulses and may comprise the three entities 132bp, 132qi, 132ce.

The first entity 132bp for finding the best prediction uses the past pulses and the pulse waveform to determine the iSOURCE, shift, GP′ and prediction residual. The quantize impulses entity 132gi quantizes the prediction residual and outputs GI′ and the impulses. The entity 132ce is configured to calculate and apply a correction factor. All this information together with the pulse waveform are received by the entity 132ce for correcting the energy, so as to output the coded impulse. The following algorithm may be used according to embodiments:

For finding and coding the impulses the following algorithm is used:
1. Absolute pulse waveform |x|_{P}_{ᵢ} is constructed using full-wave rectification:

|x|_{P}_{ᵢ}[n]=|x_{P}_{ᵢ}[n], 0≤n>L_{W}_{_{P}}
2. Vector with the number of impulses at each location └x┘_{P}_{ᵢ} is initialized with zeros:

└x┘_{P}_{ᵢ}[n]=0,0≤n>L_{W}_{_{P}}
3. Location of the maximum in |x|_{P}_{ᵢ} is found:

$${\hat{n}}_{x} = {arg max}_{0 \leq m < {L}_{{W}_{P}}} {\vert x \vert}_{{P}_{i}} [ m ]$$

4. Vector with the number of impulses is increased for one at the location of the found maximum └x┘_{P}_{ᵢ}[\hat{n}ₓ]:

└x┘_{P}_{ᵢ}[\hat{n}ₓ]=└x┘_{P}_{ᵢ}[\hat{n}ₓ]+1
5. The maximum in |x|_{P}_{ᵢ} is reduced:

$${\vert x \vert}_{{P}_{i}} [ {\hat{n}}_{x} ] = \frac{\vert {x}_{{P}_{i}} [ {\hat{n}}_{x} ] \vert}{1 + {[ x ]}_{{P}_{i}} [ {\hat{n}}_{x} ]}$$

6. The steps 3-5 are repeated until the needed number of impulses are found, where the number of pulses is equal to Σ└x┘_{P}_{ᵢ}[n]

Notice that the impulses may have the same location. Locations of the impulses are ordered by their distance from the pulse center. The location of the first impulse is absolutely coded. The locations of the following impulses are differentially coded with probabilities dependent on the position of the previous impulse. Huffman coding is used for the impulse location. Sign of each impulse is also coded. If multiple impulses share the same location then the sign is coded only once.

Gain [symbol] that maximizes the SNR is used for scaling the innovation ż_{P}_{ᵢ} consisting of the impulses. The innovation gain is non-uniformly quantized with 2 to 4 bits, depending on the number of pulses N_{P}_{_{C}}.

The first estimate for quantization of the flattened pulse waveform ź_{P}_{ᵢ} is then:

$${{P}_{i}}_{} = Q ( {{P}_{{P}_{i}}}_{} ) {\tilde{z}}_{{P}_{i}} + Q ( {{I}_{{P}_{i}}}_{} ) {\dot{z}}_{{P}_{i}}$$

where Q( ) denotes quantization.

Because the gains are found by maximizing the SNR, the energy of ź_{P}_{ᵢ} can be much lower than the energy of the original target y_{P}_{ᵢ}. To compensate the energy reduction a correction factor c_{g} is calculated:

$${c}_{g} = max ( 1 , {( \frac{{\sum }_{n = 0}^{{L}_{{W}_{P}}} {( {y}_{{P}_{i}} [ n ] )}^{2}}{{\sum }_{n = 0}^{{L}_{{W}_{P}}} {( {{P}_{i}}_{} [ n ] )}^{2}} )}^{0.25} )$$

The final gains are then:

$${g}_{{P}_{{P}_{i}}} = \{ \begin{matrix}{c}_{g} {{P}_{{P}_{i}}}_{} , & Q ( {{P}_{{P}_{i}}}_{} ) > 0 \\ 0 , & Q ( {{P}_{{P}_{i}}}_{} ) = 0\end{matrix}$$

$${g}_{{I}_{{P}_{i}}} = {c}_{g} {{I}_{{P}_{i}}}_{}$$

The memory for the prediction is updated using the quantized flattened pulse waveform z_{P}_{ᵢ}:

$${z}_{{P}_{i}} = Q ( {g}_{{P}_{{P}_{i}}} ) {\tilde{z}}_{{P}_{i}} + Q ( {g}_{{I}_{{P}_{i}}} ) {\dot{z}}_{{P}_{i}}$$

At the end of coding of N_{P}_{_{P}}≥3 quantized flattened pulse waveforms are kept in memory for prediction in the following frames.

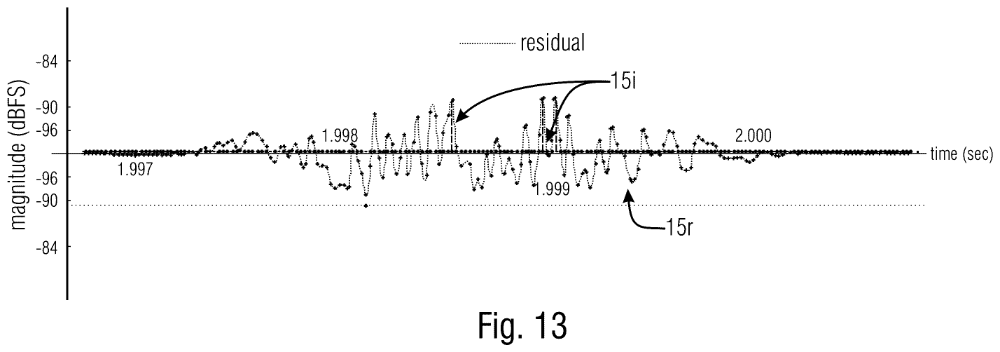

The resulting 4 scaled impulses 15i of the residual signal 15r are illustrated by FIG. 13. In detail the scaled impulses 15i represent Q ( [symbol] ) ż_{P}_{ᵢ}, i.e. the innovation ż_{P}_{ᵢ} consisting of the impulses scaled with the quantized version of the gain [symbol] .

Below, taking reference to FIG. 14 the approach for reconstructing pulses will be discussed.

FIG. 14 shows an entity 220 for reconstructing a single pulse waveform. The below discussed approach for reconstructing a single pulse waveform is multiple times executed for multiple pulse waveforms. The multiple pulse waveforms are used by the entity 22′ of FIG. 15 to reconstruct a waveform that includes the multiple pulses. From another point of view, the entity 220 processes signal consisting of a plurality of coded pulses and a plurality of pulse spectral envelopes and for each coded pulse and an associated pulse spectral envelope outputs single reconstructed pulse waveform, so that at the output of the entity 220 is a signal consisting of a plurality of the reconstructed pulse waveforms.

The entity 220 comprises a plurality of sub-entities, for example, the entity 220cpw for constructing spectrally flattened pulse waveform, an entity 224 for generating a pulse spectrogram (phase and magnitude spectrogram) of the spectrally flattened pulse waveform and an entity 226 for spectrally shaping the pulse magnitude spectrogram. This entity 226 uses a magnitude spectrogram as well as a pulse spectral envelope. The output of the entity 226 is fed to a converter for converting the pulse spectrogram to a waveform which is marked by the reference numeral 228. This entity 228 receives the phase spectrogram as well as the spectrally shaped pulse magnitude spectrogram, so as to reconstruct the pulse waveform. It should be noted, that the entity 220cpw (configured for constructing a spectrally flattened pulse waveform) receives at its input a signal describing a coded pulse. The constructor 220cpw comprises a kind of feedback loop including an update memory 229. This enables that the pulse waveform is constructed taking into account past pulses. Here the previously constructed pulse waveforms are fed back so that past pulses can be used by the entity 220cpw for constructing the next pulse waveform. Below, the functionality of this pulse reconstructor 220 will be discussed. To be noted that at the decoder side there are only the quantized flattened pulse waveforms (also named decoded flattened pulse waveforms or coded flattened pulse waveforms) and since there are no original pulse waveforms on the decoder side, we use the flattened pulse waveforms for naming the quantized flattened pulse waveforms at the decoder side and the pulse waveforms for naming the quantized pulse waveforms (also named decoded pulse waveforms or coded pulse waveforms or decoded pulse waveforms).

For reconstructing the pulses on the decoder side 220, the quantized flattened pulse waveforms are constructed (cf. entity 220cpw) after decoding the gains ( [symbol] and [symbol] ), impulses/innovation, prediction source ( [symbol] ) and offset ( [symbol] ). The memory 229 for the prediction is updated (in the same way as in the encoder in the entity 132m). The STFT (cf. entity 224) is then obtained for each pulse waveform. For example, the same 2 milliseconds long squared sine windows with 75% overlap are used as in the pulse extraction. The magnitudes of the STFT are reshaped using the decoded and smoothed spectral envelope and zeroed out below the pulse starting frequency f_{P}_{ᵢ}. Simple multiplication of magnitudes with the envelope may be used for shaping the STFT (cf. entity 226). The phases are not modified. Reconstructed waveform of the pulse is obtained from the STFT via the inverse DFT, windowing and overlap and add (cf. entity 228). Alternatively the envelope can be shaped via an FIR or some other filter and each pulse waveform can be high-pass filtered with the high-pass filter cutoff set to the pulse starting frequency f_{P}_{ᵢ}, avoiding the STFT. Zeroing out the STFT below the pulse starting frequency f_{P}_{ᵢ} and high-pass filtering with the high-pass filter cutoff set to the pulse starting frequency f_{P}_{ᵢ} have the same effect on each pulse waveform to comprise high-pass characteristics and/or a characteristics having more energy at frequencies starting above a start frequency.

FIG. 15 shows the entity 22′ subsequent to the entity 228 which receives a plurality of reconstructed waveforms of the pulses as well as the positions of the pulses so as to construct the waveform y_{P} (cf. FIG. 2a, 2c). This entity 22′ is used for example as the last entity within the waveform constructor 22 of FIG. 1a or 2a or 2c.

The reconstructed pulse waveforms are concatenated based on the decoded positions t_{P}_{ᵢ}, inserting zeros between the pulses in the entity 22′ in FIG. 15. The concatenated waveform (y_{P}) is added to the decoded signal (cf. 23 in FIG. 2a or FIG. 2c). The entities 22′ in FIGS. 15 and 114 in FIG. 6 have the same functionality.

The reconstructed pulse waveforms are concatenated based on the decoded positions t_{P}_{ᵢ}, inserting zeros between the reconstructed pulses (the reconstructed pulse waveforms). In some cases the reconstructed pulse waveforms may overlap in the concatenated waveform (y_{P}) and in this case no zeros are inserted between the pulse waveforms. The concatenated waveform (y_{P}) is added to the decoded signal. In the same manner the original pulse waveforms x_{P}_{ᵢ} are concatenated and subtracted from the input of the MDCT based codec.

The reconstructed pulse waveform are not perfect representations of the original pulses. Removing the reconstructed pulse waveform from the input would thus leave some of the transient parts of the signal. As transient signals cannot be well presented with an MDCT codec, noise spread across whole frame would be present and the advantage of separately coding the pulses would be reduced. For this reason the original pulses are removed from the input.

According to embodiments the HF tonality flag ϕ_{H} may be defined as follows:

Normalized correlation ρ_{HF} is calculate on y_{MHF} between the samples in the current window and a delayed version with d̅_{F}_{₀} (or d̅_{F}_{_{corrected}}) delay, where y_{MHF} is a high-pass filtered version of the pulse residual signal y_{M}. For an example a high-pass filter with the crossover frequency around 6 kHz may be used.

n_{NFTonalCurr}n_{HFTonal}=0.5·n_{HFTonal}+n_{HFTonalCurr} For each MDCT frequency bin above a specified frequency, it is determined, as in 5.3.3.2.5 of [7], if the frequency bin is tonal or noise like. The total number of tonal frequency bins is calculated in the current frame and additionally smoothed total number of tonal frequencies is calculated as.

HF tonality flag ϕ_{H} is set to 1 if the TNS is inactive and the pitch contour is present and there is tonality in high frequencies, where the tonality exists in high frequencies if ρ_{HF}>0 or n_{HFTonal}>1 .

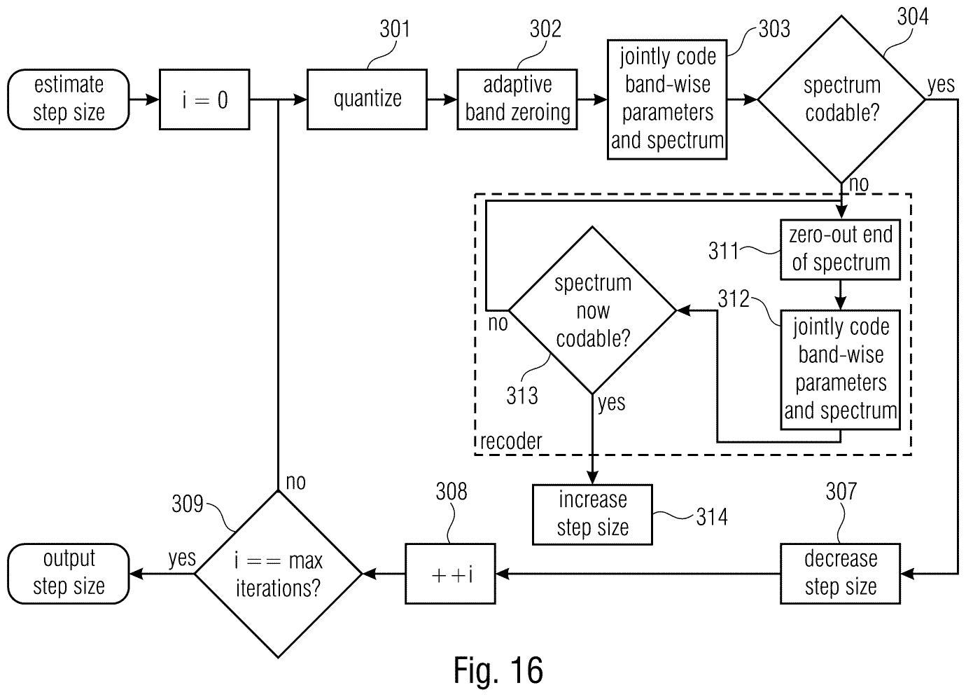

With respect to FIG. 16 the iBPC approach is discussed. The process of obtaining the optimal quantization step size g_{Qo} will be explained now. The process may be an integral part of the block iBPC. Note iBPC of FIG. 16 outputs g_{Q}_{₀} based on X_{MR}. In another apparatus X_{MR} and g_{Q}_{₀} may be used as input (for details cf. FIG. 3).

FIG. 16 shows a flow chart of an approach for estimating a step size. The process start, with i=0 wherein then the four steps of quantize, adaptive band zeroing, determining jointly band-wise parameters and spectrum and determine whether the spectrum is codeable are performed. These steps are marked by the reference numerals 301 to 304. In case the spectrum is codeable the step size is decreased (cf. step 307) a next iteration ++i is performed cf. reference numeral 308. This is performed as long as i is not equal to the maximum iteration (cf. decision step 309). In case the maximum iteration is achieved the step size is output. In case the maximum iterations are not achieved the next iteration is performed.

In case, the spectrum is not codeable, the process having the steps 311 and 312 together with the verifying step (spectrum now codeable) 313 is applied. After that the step size is increased (cf. 314) before initiating the next iteration (cf. step 308).

A spectrum X_{MR}, which spectral envelope is perceptually flattened, is scalar quantized using single quantization step size g Q across the whole coded bandwidth and entropy coded for example with a context based arithmetic coder producing a coded spect. The coded spectrum bandwidth is divided into sub-bands Bᵢ of increasing width L_{B}_{ᵢ}.

The optimal quantization step size g_{Qo}, also called global gain, is iteratively found as explained.

In each iteration the spectrum X MR is quantized in the block Quantize to produce X_{Q1}. In the block “Adaptive band zeroing” a ratio of the energy of the zero quantized lines and the original energy is calculated in the sub-bands Bᵢ and if the energy ratio is above an adaptive threshold τ_{B}_{ᵢ}, the whole sub-band in X_{Q1} is set to zero. The thresholds τ_{B}_{ᵢ} are calculated based on the tonality flag ϕ_{H} and flags [symbol] , where the flags [symbol] indicate if a sub-band was zeroed-out in the previous frame:

$${τ}_{{B}_{i}} = \frac{1 + ( \frac{1}{2} + {{N}_{{B}_{i}}}_{} ) {ϕ}_{H}}{2}$$

For each zeroed-out sub-band a flag [symbol] is set to one. At the end of processing the current frame, [symbol] are copied to [symbol] . Alternatively there could be more than one tonality flag and a mapping from the plurality of the tonality flags into tonality of each sub-band, producing a tonality value for each sub-band [symbol] . The values of τ_{B}_{ᵢ} may for example have a value from a set of values {0.25, 0.5, 0.75}. Alternatively other decision may be used to decide based on the energy of the zero quantized lines and the original energy and on the contents X_{Q1} and X_{MR} of whether to set the whole sub-band i in X_{Q1} to zero.

A frequency range where the adaptive band zeroing is used may be restricted above a certain frequency f_{ABZStart}, for example 7000 Hz, extending the adaptive band zeroing as long, as the lowest sub-band is zeroed out, down to a certain frequency f_{ABZMin}, for example 700 Hz.

The individual zero filling levels (individual zfl) of sub-bands of X_{Q1} above f_{EZ}, where f_{EZ} is for an example 3000 Hz that are completely zero is explicitly coded and additionally one zero filling level (zflₛₘₐₗₗ) for all zero sub-bands bellow f_{EZ} nd all zero sub-bands above f_{EZ} quantized to zero is coded. A sub-band of X_{Q1} may be completely zero because of the quantization in the block Quantize even if not explicitly set to zero by the adaptive band zeroing. The needed number of bits for the entropy coding of the zero filling levels (zfl consisting of the individual zfl and the zflₛₘₐₗₗ) and the spectral lines in X_{Q1} is calculated. Additionally the number of spectral lines N_{Q} that can be explicitly coded with the available bit budget is found. N_{Q} is an integral part of the coded spect and is used in the decoder to find out how many bits are used for coding the spectrum lines; other methods for finding the number of bits for coding the spectrum lines may be used, for example using special EOF character. As long as there is not enough bits for coding all non-zero lines, the lines in X_{Q1} above N_{Q} are set to zero and the needed number of bits is recalculated.

For the calculation of the bits needed for coding the spectral lines, bits needed for coding lines starting from the bottom are calculated. This calculation is needed only once as the recalculation of the bits needed for coding the spectral lines is made efficient by storing the number of bits needed for coding n lines for each n≤N_{Q}.

In each iteration, if the needed number of bits exceeds the available bits, the global gain g_{Q} is decreased (307), otherwise g_{Q} is increased (314). In each iteration the speed of the global gain change is adapted. The same adaptation of the change speed as in the rate-distortion loop from the EVS [20] may be used to iteratively modify the global gain. At the end of the iteration process, the optimal quantization step size g_{Qo} is equal to g_{Q} that produces optimal coding of the spectrum, for example using the criteria from the EVS, and X_{Q} is equal to the corresponding X_{Q1}.

Instead of an actual coding, an estimation of maximum number of bits needed for the coding may be used. The output of the iterative process is the optimal quantization step size g_{Qo}; the output may also contain the coded spect and the coded noise filling levels (zfl), as they are usually already available, to avoid repetitive processing in obtaining them again.

Below, the zero-filling will be discussed in detail.

According to embodiments, the block “Zero Filling” will be explained now, starting with an example of a way to choose the source spectrum.

For creating the zero filling, following parameters are adaptively found:
an optimal long copy-up distance \dot{d}_{C}
a minimum copy-up distance ď_{C}
a minimum copy-up source start sš_{C}
a copy-up distance shift Δ_{C}

The optimal copy-up distance \dot{d}_{C} determines the optimal distance if the source spectrum is the already obtained lower part of X_{CT}. The value of \dot{d}_{C} is between the minimum \dot{d}_{Č}, that is for an example set to an index corresponding to 5600 Hz, and the maximum \dot{d}_{Ĉ}, that is for an example set to an index corresponding to 6225 Hz. Other values may be used with a constraint \dot{d}_{Č}<\dot{d}_{Ĉ}.

The distance between harmonics [symbol] is calculated from an average pitch lag d̅_{F}_{₀}, where the average pitch lag d̅_{F}_{₀} is decoded from the bit-stream or deduced from parameters from the bit-stream (e.g. pitch contour). Alternatively [symbol] may be obtained by analyzing X_{DT} or a derivative of it (e.g. from a time domain signal obtained using X_{DT}). The distance between harmonics [symbol] is not necessarily an integer. If d̅_{F}_{₀}=0 then [symbol] is set to zero, where zero is a way of signaling that there is no meaningful pitch lag.

The value of [symbol] is the minimum multiple of the harmonic distance [symbol] larger than the minimal optimal copy-up distance \dot{d}_{Č}:

$${d}_{{C}_{{F}_{0}}} = ⌊ {Δ}_{{X}_{{F}_{0}}} ⌈ \frac{{\dot{d}}_{\breve{C}}}{{Δ}_{{X}_{{F}_{0}}}} ⌉ + 0.5 ⌋$$

If [symbol] is zero then [symbol] is not used.

The starting TNS spectrum line plus the TNS order is denoted as i_{T}, it can be for example an index corresponding to 1000 Hz.

If TNS is inactive in the frame i_{C}_{_{S}} is set to [symbol] If TNS is active i_{C}_{_{S}} is set to i_{T}, additionally lower bound by [symbol] if HFs are tonal (e.g. if ϕ_{H} is one).

Magnitude spectrum Z_{C} is estimated from the decoded spect X_{DT}:

$${Z}_{C} [ n ] = \sqrt{{\sum }_{m = - 2}^{2} {( {X}_{DT} [ n + m ] )}^{2}}$$

A normalized correlation of the estimated magnitude spectrum is calculated:

$${ρ}_{C} [ n ] = \frac{{\sum }_{m = 0}^{{L}_{{C}^{- 1}}} {Z}_{C} [ {i}_{{C}_{S}} + m ] {Z}_{C} [ {i}_{{C}_{S}} + n + m ]}{\sqrt{( {\sum }_{m = 0}^{{L}_{{C}^{- 1}}} {Z}_{C} [ {i}_{{C}_{S}} + m ] {Z}_{C} [ {i}_{{C}_{S}} + m ] ) ( {\sum }_{m = 0}^{{L}_{{C}^{- 1}}} {Z}_{C} [ {i}_{{C}_{S}} + n + m ] {Z}_{C} [ {i}_{{C}_{S}} + n + m ] )}} , {\dot{d}}_{\breve{C}} \leq n \leq {\dot{d}}_{\breve{C}}$$

The length of the correlation L_{C} is set to the maximum value allowed by the available spectrum, optionally limited to some value (for example to the length equivalent of 5000 Hz).

Basically we are searching for n that maximizes the correlation between the copy-up source Z_{C}[i_{C}_{_{S}}+m] and the destination Z_{C}[i_{C}_{_{S}}+n+m], where 0≤m<L_{C}.

We choose d_{C}_{_{ρ}} among n (\dot{d}_{Č}≤n≤\dot{d}_{Ĉ}) where ρ_{C} has the first peak and is above mean of ρ_{C}, that is:

$${ρ}_{C} [ {d}_{{C}_{ρ}} - 1 ] \leq {ρ}_{C} [ {d}_{{C}_{ρ}} ] \leq {ρ}_{C} [ {d}_{{C}_{ρ}} + 1 ] and {ρ}_{C} [ {d}_{{C}_{ρ}} ] \geq \frac{{\sum }_{n} {ρ}_{C} [ n ]}{{\dot{d}}_{\hat{C}} - {\dot{d}}_{\breve{C}}}$$

and for every m≤d_{C}_{_{ρ}} it is not fulfilled that ρ_{C}[m−1]≤ρ_{C}[m]≤ρ_{C}[m+1]. In other implementation we can choose d_{C}_{_{ρ}} so that it is an absolute maximum in the range from \dot{d}_{Č} to \dot{d}_{Ĉ}. Any other value in the range from \dot{d}_{Č} to \dot{d}_{Ĉ} may be chosen for d_{C}_{_{ρ}}, where an optimal long copy up distance is expected.

If the TNS is active we may choose \dot{d}_{C}=d_{C}_{_{ρ}}.

If the TNS is inactive

$${\dot{d}}_{C} = {ℱ}_{C} ( {ρ}_{C} , {d}_{{C}_{ρ}} , {d}_{{C}_{{F}_{0}}} , {{d}^{`}}_{C} , {{ρ}^{`}}_{C} [ {{d}^{`}}_{C} ] , {Δ}_{{\overline{d}}_{{F}_{0}}} , {{ϕ}^{`}}_{{T}_{C}} ) ,$$

where \grave{ρ}_{C} is the normalized correlation and \grave{d}_{C} the optimal distance in the previous frame. The flag \grave{ϕ}_{T}_{_{C}} indicates if there was change of tonality in the previous frame. The function [symbol] _{C} returns either d_{C}_{_{ρ}}, [symbol] or \grave{d}_{C}. The decision which value to return in [symbol] _{C} is primarily based on the values ρ_{C}[d_{C}_{_{ρ}}], ρ_{C}[ [symbol] ] and ρ_{C}[\grave{d}_{C}]. If the flag \grave{ϕ}_{T}_{_{C}} is true and ρ_{C}[d_{C}_{_{ρ}}] or ρ_{C}[ [symbol] ] are valid than ρ_{C}[\grave{d}_{C}] is ignored. The values of \grave{ρ}_{C}[\grave{d}_{C}] and [symbol] are used in rare cases.

In an example [symbol] could be defined with the following decisions:
d_{C}_{_{ρ}} is returned if ρ_{C}[d_{C}_{_{ρ}}] is larger than μ_{C}[ [symbol] ] for at least [symbol] and larger than ρ_{C}[\grave{d}_{C}] for at least [symbol] , where [symbol] and [symbol] are adaptive thresholds that are proportional to the |d_{C}_{_{ρ}}− [symbol] | and |d_{C}_{_{ρ}}−\grave{d}_{C}| respectively. Additionally it may be requested that ρ_{C}[d_{C}_{_{ρ}}] is above some absolute threshold, for an example 0.5
otherwise [symbol] is returned if ρ_{C}[ [symbol] ] is larger than ρ_{C}[\grave{d}_{C}] for at least a threshold, for example 0.2
otherwise d_{C}_{_{ρ}} is returned if \grave{ϕ}_{T}_{_{C}} is set and ρ_{C}[d_{C}_{_{ρ}}]>0
otherwise [symbol] is returned if \grave{ϕ}_{T}_{_{C}} is set and the value of [symbol] is valid, that is if there is a meaningful pitch lag
otherwise [symbol] is returned if \grave{ρ}_{C}[\grave{d}_{C}] is small, for example below 0.1, and the value of [symbol] is valid, that is if there is a meaningful pitch lag, and the pitch lag change from the previous frame is small
otherwise \grave{d}_{C} is returned

The flag \grave{ϕ}_{T}_{_{C}} is set to true if TNS is active or if ρ_{C}[\dot{d}_{C}]<τ_{T}_{_{C}} and the tonality is low, the tonality being low for an example if ϕ_{H} is false or if d̅_{F}_{₀} is zero. τ_{T}_{_{C}} is a value smaller than 1, for example 0.7. The value set to \grave{ϕ}_{T}_{_{C}} is used in the following frame.

The percentual change of d̅_{F}_{₀} between the previous frame and the current frame [symbol] is also calculated.

The copy-up distance shift Δ_{C} is set to [symbol] unless the optimal copy-up distance \dot{d}_{C} is equivalent to \grave{d}_{C} and [symbol] <τ_{Δ}_{_{F}} (τ_{Δ}_{_{F}} being a predefined threshold), in which case Δ_{C} is set to the same value as in the previous frame, making it constant over the consecutive frames. [symbol] is a measure of change (e.g. a percentual change) of d̅_{F}_{₀} between the previous frame and the current frame. τ_{Δ}_{_{F}} could be for example set to 0.1 if [symbol] is the perceptual change of d̅_{F}_{₀}. If TNS is active in the frame Δ_{C} is not used.

The minimum copy up source start š_{C} can for an example be set to i_{T} if the TNS is active, optionally lower bound by └2.5 [symbol] ┘ if HFs are tonal, or for an example set to └2.5Δ_{C}┘ if the TNS is not active in the current frame.

The minimum copy-up distance ď_{C} is for an example set to ┌Δ_{C}┐ if the TNS is inactive. If TNS is active, ď_{C} is for an example set to š_{C} if HF are not tonal, or ď_{C} is set for an example to

$$⌈ {Δ}_{{X}_{{F}_{0}}} ⌈ \frac{{\check{s}}_{C}}{{Δ}_{{X}_{{F}_{0}}}} ⌉ ⌉$$

if HFs are tonal.

Using for example X_{N}[−1]=Σₙ2n|X_{D}[n]| as an initial condition, a random noise spectrum X_{N} is constructed as X_{N}[n]=short(31821X_{N}[n−1]+13849), where the function short truncates the result to 16 bits. Any other random noise generator and initial condition may be used. The random noise spectrum X_{N} is then set to zero at the location of non-zero values in X_{D} and optionally the portions in X_{N} between the locations set to zero are windowed, in order to reduce the random noise near the locations of non-zero values in X_{D}.

For each sub-band Bᵢ of length L_{B}_{ᵢ}, starting at j_{B}_{ᵢ} in X_{CT} a source spectrum for [symbol] is found. The sub-band division may be the same as the sub-band division used for coding the zfl, but also can be different, higher or lower.

For an example if TNS is not active and HFs are not tonal then the random noise spectrum X_{N} is used as the source spectrum for all sub-bands. In another example X_{N} is used as the source spectrum for the sub-bands where other sources are empty or for some sub-bands which start below minimal copy-up destination: š_{C}+min(ď_{C}, L_{B}_{ᵢ}).

In another example if the TNS is not active and HFs are tonal, a predicted spectrum X_{NP} may be used as the source for the sub-bands which start below š_{C}+\dot{d}_{C} and in which E_{B} is at least 12 dB above E_{B} in neighboring sub-bands, where the predicted spectrum is obtained from the past decoded spectrum or from a signal obtained from the past decoded spectrum (for example from the decoded TD signal).

For cases not contained in the above examples, distance d_{C} may be found so that X_{CT}[s_{C}+M](0 ≤L_{B}) or a mixture of the X_{CT}[_{C}+m] and X_{N}[s_{C}+d_{C}+m] may be used as the source spectrum for [symbol] that starts at j_{B}_{ᵢ}, where s_{C}=j_{B}_{ᵢ}−d_{C}. In one example if the TNS is active, but starts only at a higher frequency (for example at 4500 Hz) and HFs are not tonal, the mixture of the X_{CT}[s_{C}+m] and X_{N}[s_{C}+d_{C}+m] may be used as the source spectrum if š_{C}+ď_{C}≤j_{B}_{ᵢ}<š_{C}+\dot{d}_{C}; in yet another example only X_{CT}[s_{C}+m] or a spectrum consisting of zeros may be used as the source. If j_{B}_{ᵢ}≥š_{C}+\dot{d}_{C} then d_{C} could be set to \dot{d}_{C}. If the TNS is active then a positive integer n may be found so that

$${j}_{{B}_{i}} - \frac{{\dot{d}}_{C}}{n} \geq {{s}^{⋁}}_{C}$$

and d_{C} may be set to

$$\frac{{\dot{d}}_{C}}{n} ,$$

for example to the smallest such integer n. If the TNS is not active, another positive integer n may be found so that j_{B}_{ᵢ}−\dot{d}_{C}+n·Δ_{C}≥š_{C} and d_{C} is set to \dot{d}_{C}−n·Δ_{C}, for example to the smallest such integer n.

In another example the lowest sub-bands [symbol] in X_{S} up to a starting frequency f_{ZFStart} may be set to 0, meaning that in the lowest sub-bands X_{CT} may be a copy of X_{DT}.

An example of weighting the source spectrum based on E_{B} in the block “Zero Filling” is given now.

In an example of smoothing the E_{B}, E_{B}_{ᵢ} may be obtained from the zfl, each E_{B}_{ᵢ} corresponding to a sub-band i in E_{B}. E_{B}_{ᵢ} are then smoothed:

$${E}_{{B}_{1 , i}} = \frac{{E}_{{B}_{i - 1}} + 7 {E}_{{B}_{i}}}{8} and {E}_{{B}_{2 , i}} = \frac{7 {E}_{{B}_{i}} + {E}_{{B}_{i + 1}}}{8} .$$

The scaling factor α_{C}_{ᵢ} is calculated for each sub-band Bᵢ depending on the source spectrum:

$${a}_{{C}_{i}} = {g}_{{Q}_{0}} \sqrt{\frac{{L}_{{B}_{i}}}{{\sum }_{m = 0}^{{L}_{{B}_{i}} - 1} {( {X}_{{S}_{{B}_{i}}} [ m ] )}^{2}}}$$

Additionally the scaling is limited with the factor b_{C}_{ᵢ} calculated as:

$${b}_{{C}_{i}} = \frac{2}{max ( 2 , {a}_{{C}_{i}} \cdot {E}_{{B}_{1 , i}} , {a}_{{C}_{i}} \cdot {E}_{{B}_{2 , i}} )}$$

The source spectrum band [symbol] [m] (0≤m<L_{B}_{ᵢ}) is split in two halves and each half is scaled, the first half with g_{C}_{_{1,i}}=b_{C}_{ᵢ}·a_{C}_{ᵢ}·E_{B}_{_{1,i}} and the second with g_{C}_{_{2,i}}=b_{C}_{ᵢ}·a_{C}_{ᵢ}·E_{B}_{_{2,i}}.

Note in the above explanation, a_{C}_{ᵢ} is derived using g_{Q}_{₀} and g_{C}_{_{1,i}} is derived using a_{C}_{ᵢ} and E_{B}_{_{1,i}} and g_{C}_{_{2,i}} is derived using a_{C}_{ᵢ} and E_{B}_{_{2,i}}. [symbol] is derived using [symbol] and g_{C}_{_{1,i}} and g_{C}_{_{2,i}}. According to further embodiments that E_{B} may be derived using g_{Q}_{₀}. For example the scaling of the source spectrum is derived using the optimal quantization step g_{Q}_{₀} is an optional additional decoder.

The scaled source spectrum band [symbol] where the scaled source spectrum band is [symbol] , is added to X_{DT}[j_{B}_{ᵢ}+m] to obtain X_{DT}[j_{B}_{ᵢ}+m].

An example of quantizing the energies of the zero quantized lines (as a part of iBPC) is given now.

X_{QZ} is obtained from X_{MR} by setting non-zero quantized lines to zero. For an example the same way as in X_{N}, the values at the location of the non-zero quantized lines in X_{Q} are set to zero and the zero portions between the non-zero quantized lines are windowed in X_{MR}, producing X_{QZ}.

The energy per band i for zero lines (E_{Z}_{ᵢ}) are calculated from X_{QZ}:

$${E}_{{Z}_{i}} = \frac{1}{{g}_{{Q}_{0}}} \sqrt{\frac{{\sum }_{m = {j}_{{B}_{i}}}^{{j}_{{B}_{i}} + {L}_{{B}_{i}} - 1} {( {X}_{QZ} [ m ] )}^{2}}{{L}_{{B}_{i}}}}$$

The E_{Z}_{ᵢ} are for an example quantized using step size ⅛ and limited to 6/8. Separate E_{Z}_{ᵢ} are coded as individual zfl only for the sub-bands above f_{EZ}, where f_{EZ} is for an example 3000 Hz, that are completely quantized to zero. Additionally one energy level E_{Z}_{_{S}} is calculated as the mean of all E_{Z}_{ᵢ} from zero sub-bands bellow f_{EZ} and from zero sub-bands above f_{EZ} where E_{Z}_{ᵢ} is quantized to zero, zero sub-band meaning that the complete sub-band is quantized to zero. The low level E_{Z}_{_{S}} is quantized with the step size 1/16 and limited to 3/16. The energy of the individual zero lines in non-zero sub-bands is estimated and not coded explicitly.

The values of E_{B}_{ᵢ} are obtained on the decoder side from zfl and the values of E_{B}_{ᵢ} for zero sub-bands correspond to the quantized values of E_{Z}_{ᵢ}. Thus, the value of E_{B} consisting of E_{B}_{ᵢ} may be coded depending on the optimal quantization step g_{Q}_{₀}. This is illustrated by FIG. 3 where the parametric coder 156pc receives as input for g_{Q}_{₀}. In another example other quantization step size specific to the parametric coder may be used, independent of the optimal quantization step g_{Q}_{₀}. In yet another example a non-uniform scalar quantizer or a vector quantizer may be used for coding zfl. Yet it is advantageous in the presented example to use the optimal quantization step g_{Q}_{₀} because of the dependence of the quantization of X_{MR} to zero on the optimal quantization step g_{Q}_{₀}.

### Long Term Prediction (LTP)

The block LTP will be explained now.

The time-domain signal y_{C} is used as the input to the LTP, where y_{C} is obtained from X_{C} as output of IMDCT. IMDCT consists of the inverse MDCT, windowing and the Overlap-and-Add. The left overlap part and the non-overlapping part of y_{C} in the current frame is saved in the LTP buffer.

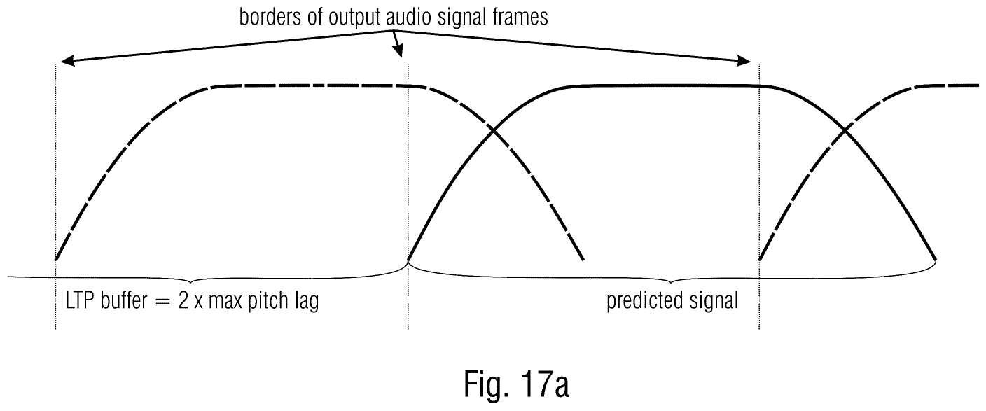

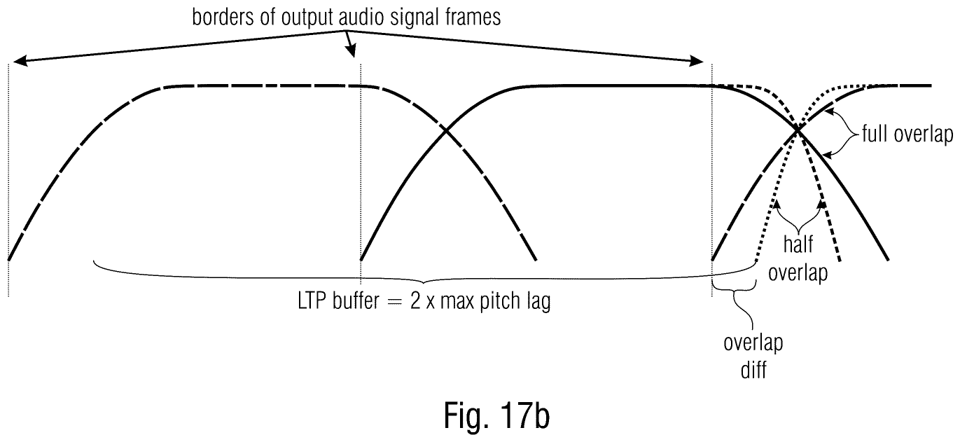

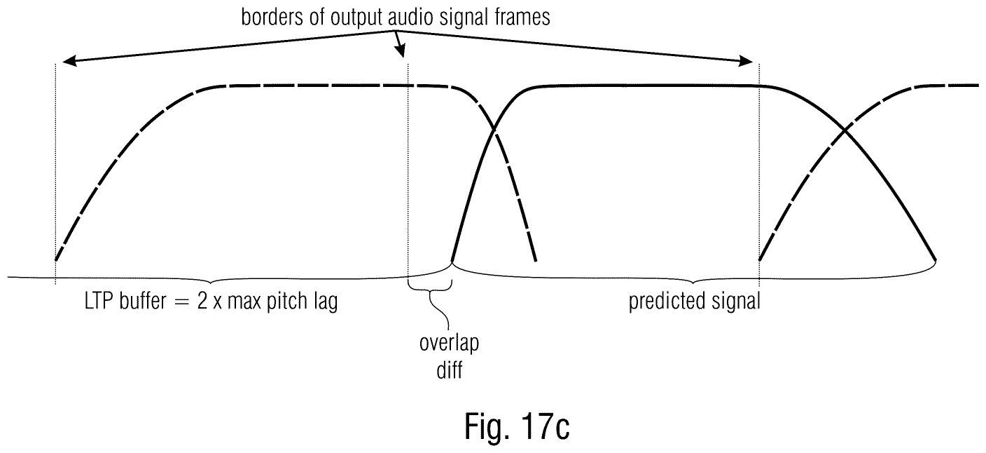

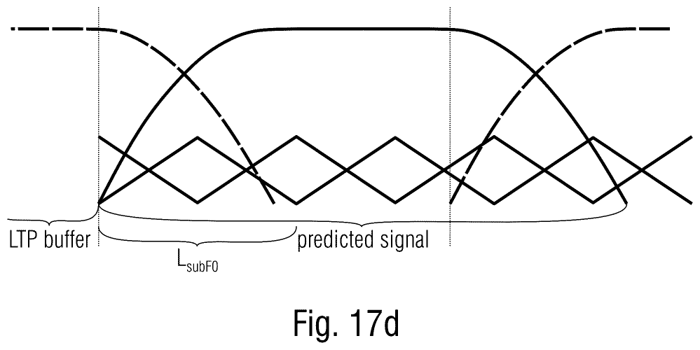

The LTP buffer is used in the following frame in the LTP to produce the predicted signal for the whole window of the MDCT. This is illustrated by FIG. 17a.

If a shorter overlap, for example half overlap, is used for the right overlap in the current window, then also the non-overlapping part “overlap diff” is saved in the LTP buffer. Thus, the samples at the position “overlap diff” (cf. FIG. 17b) will also be put into the LTP buffer, together with the samples at the position between the two vertical lines before the “overlap diff”. The non-overlapping part “overlap duff” is not in the decoder output in the current frame, but only in the following frame (cf. FIGS. 17b and 17c).

If a shorter overlap is used for the left overlap in the current window, the whole non-overlapping part up to the start of the current window is used as a part of the LTP buffer for producing the predicted signal.

The predicted signal for the whole window of the MDCT is produced from the LTP buffer. The time interval of the window length is split into overlapping sub-intervals of length L_{subF0} with the hop size L_{updateF0}=L_{subF0}/2. Other hop sizes and relations between the sub-interval length and the hop size may be used. The overlap length may be L_{updateF0}−L_{subF0} or smaller. L_{subF0} is chosen so that no significant pitch change is expected within the sub-intervals. In an example L_{updateF0} is an integer closest to d̅_{F}_{₀}/2, but not greater than d̅_{F}_{₀}/2, and L_{subF0} is set to 2L_{updateF0}. As illustrated by FIG. 17d. In another example it may be additionally requested that the frame length or the window length is divisible by L_{updateF0}.

Below, an example of “calculation means (1030) configured to derive sub-interval parameters from the encoded pitch parameter dependent on a position of the sub-intervals within the interval associated with the frame of the encoded audio signal” and also an example of “parameters are derived from the encoded pitch parameter and the sub-interval position within the interval associated with the frame of the encoded audio signal” will be given. For each sub-interval pitch lag at the center of the sub-interval i_{subCenter} is obtained from the pitch contour. In the first step, the sub-interval pitch lag d_{subF0} is set to the pitch lag at the position of the sub-interval center d_{contour}[i_{subCenter}]. As long as the distance of the sub-interval end to the window start (i_{subCenter}+L_{subF0}/2) is bigger than d_{subF0}, d_{subF0} is increased for the value of the pitch lag from the pitch contour at position d_{subF0} to the left of the sub-interval center, that is d_{subF0}=d_{subF0}+d_{contour}[i_{subCenter}−d_{subF0}] until i_{subCenter}+L_{subF0}/2<d_{subF0}. The distance of the sub-interval end to the window start (i_{subCenter}+L_{subF0}/2) may also be termed the sub-interval end.

In each sub-interval the predicted signal is constructed using the LTP buffer and a filter with the transfer function H_{LTP}(z), where:

H_{LTP}(z)=B(z,T_{fr})z^{-T}^{ᵢₙₜ}

where Tᵢₙₜ is the integer part of d_{subF0}, that is Tᵢₙₜ=└d_{subF0}┘, and T_{fr} is the fractional part of d_{subF0}, that is T_{fr}=d_{subF0}−Tᵢₙₜ, and B(z,T_{fr}) is a fractional delay filter. B(z,T_{fr}) may have a low-pass characteristics (or it may de-emphasize the high frequencies). The prediction signal is then cross-faded in the overlap regions of the sub-intervals. H_{LTP2}(z) Alternatively the predicted signal can be constructed using the method with cascaded filters as described in [8], with zero input response (ZIR) of a filter based on the filter with the transfer function and the LTP buffer used as the initial output of the filter, where:

$${H}_{LTP 2} ( z ) = \frac{1}{1 - gB ( z , {T}_{fr} ) {z}^{- {T}_{int}}}$$

Examples for B(z,T_{fr}):

$$B ( z , \frac{0}{4} ) = 0. {z}^{- 2} + 0.2325 {z}^{- 1} + 0.5349 {z}^{0} + 0.2325 {z}^{1}$$

$$B ( z , \frac{1}{4} ) = 0.0152 {z}^{- 2} + 0.34 {z}^{- 1} + 0.5094 {z}^{0} + 0.1353 {z}^{1}$$

$$B ( z , \frac{2}{4} ) = 0.0609 {z}^{- 2} + 0.4391 {z}^{- 1} + 0.4391 {z}^{0} + 0.0609 {z}^{1}$$

$$B ( z , \frac{3}{4} ) = 0.1353 {z}^{- 2} + 0.5094 {z}^{- 1} + 0.34 {z}^{0} + 0.0152 {z}^{1}$$

In the examples T_{fr} is usually rounded to the nearest value from a list of values and for each value in the list the filter B is predefined.

The predicted signal XP′ (cf. FIG. 1a) is windowed, with the same window as the window used to produce X_{M}, and transformed via MDCT to obtain X_{P}.

Below, an example of means for modifying the predicted spectrum, or a derivative of the predicted spectrum, dependent on a parameter derived from the encoded pitch parameter will be given. The magnitudes of the MDCT coefficients at least n_{Fsafeguard} away from the harmonics in X_{P} are set to zero (or multiplied with a positive factor smaller than 1), where n_{Fsafeguard} is for example 10. Alternatively other windows than the rectangular window may be used to reduce the magnitudes between the harmonics. It is considered that the harmonics in X_{P} are at bin locations that are integer multiples of iF0=2L_{M}/d̅_{F}_{_{corrected}}, where L_{M} is X_{P} length and d̅_{F}_{_{corrected}} is the average corrected pitch lag. The harmonic locations are └n·iF0┘. This removes noise between harmonics, especially when the half pitch lag is detected.

The spectral envelope of X_{P} is perceptually flattened with the same method as X_{M}, for example via SNS_{E}, to obtain X_{PS}.

Below an example of “a number of predictable harmonics is determined based on the coded pitch parameter is given. Using X_{PS}, X_{MX} and d̅_{F}_{_{corrected}} the number of predictable harmonics n_{LTP} is determined. n_{LTP} is coded and transmitted to the decoder. Up to N_{LTP} harmonics may be predicted, for example N_{LTP}=8. X_{PS} and X_{MS} are divided into N_{LTP} bands of length └iF0+0.5┘, each band starting at └(n−0.5)iF0┘, n∈{1, . . . , N_{LTP}}. n_{LTP} is chosen so that for all n≤n_{LTP} the ratio of the energy of X_{MS}−X_{PS} and X_{MS} is below a threshold τ_{LTP}, for example τ_{LTP}=0.7. If there is no such n, then n_{LTP}=0 and the LTP is not active in the current frame. It is signaled with a flag if the LTP is active or not. Instead of X_{PS} and X_{MS}, X_{P} and X_{M} may be used. Instead of X_{PS} and X_{MS}, X_{PS} and X_{MT} may be used. Alternatively, the number of predictable harmonics may be determined based on a pitch contour d_{contour}.

Below, an example of a combiner (157) configured to combine at least a portion of the prediction spectrum (X_{P}) or a portion of the derivative of the predicted spectrum (X_{PS}) with the error spectrum (X_{D}) will be given. If the LTP is active then first └(n_{LTP}+0.5)iF0┘ coefficients of X_{PS}, except the zeroth coefficient, are subtracted from X_{MT} to produce X_{MR}. The zeroth and the coefficients above └(n_{LTP}+0.5)iF0┘ are copied from X_{MT} to X_{MR}.

In a process of a quantization, X_{Q} is obtained from X_{MR}, and X_{Q} is coded as spect, and by decoding X_{D} is obtained from spect.

If the LTP is active then first └(n_{LTP}+0.5)iF0┘ coefficients of X_{PS}, except the zeroth coefficient, are added to X_{D} to produce X_{DT}. The zeroth and the coefficients above └(n_{LTP}+0.5)iF0┘ are copied from X_{D} to X_{DT}.

Below, the optional features of harmonic post-filtering will be discussed.

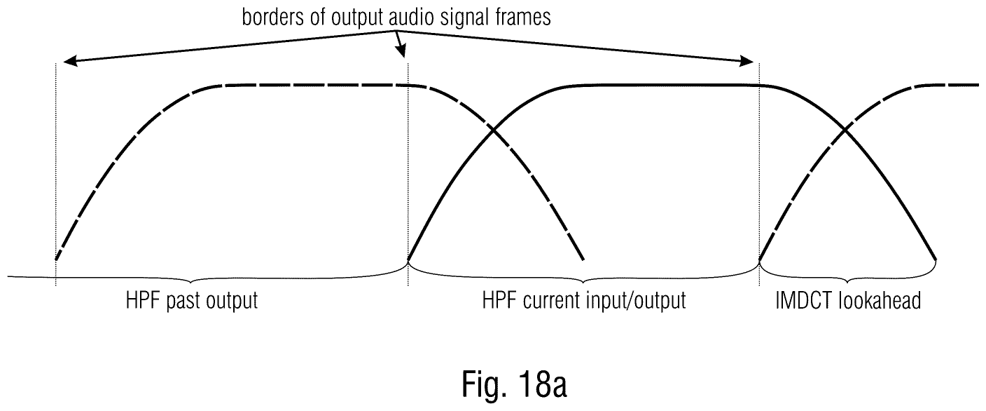

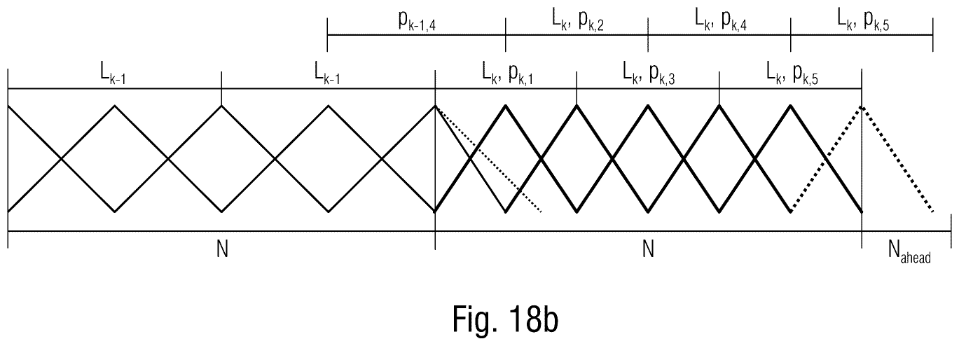

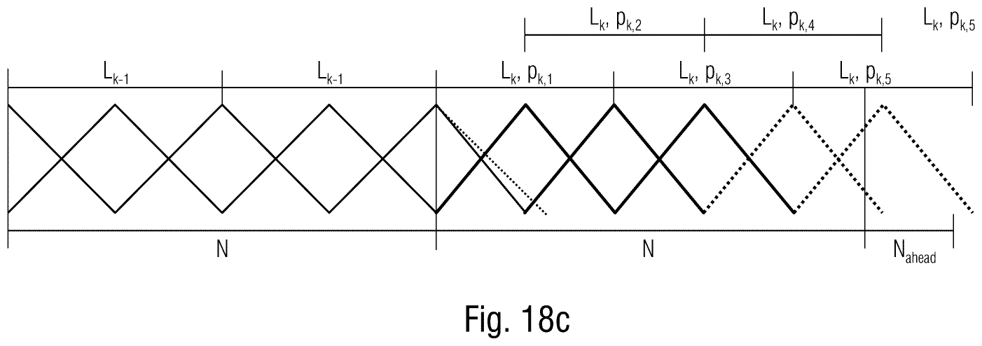

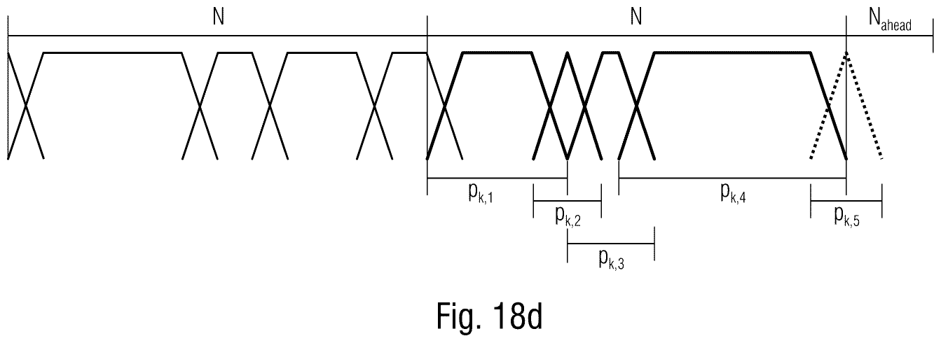

A time-domain signal y_{C} is obtained from X_{C} as output of IMDCT where IMDCT consists of the inverse MDCT, windowing and the Overlap-and-Add. A harmonic post-filter (HPF) that follows pitch contour is applied on y_{C} to reduce noise between harmonics and to output y_{H}. Instead of y_{C}, a combination of y_{C} and a time domain signal y_{P}, constructed from the decoded pulse waveforms, may be used as the input to the HPF. As illustrated by FIG. 18a.

The HPF input for the current frame k is y_{C}[n](0≤n<N). The past output samples y_{H}[n] (−d_{HPFmax}≤n<0, where d_{HPFmax} is at least the maximum pitch lag) are also available. N_{ahead} IMDCT look-ahead samples are also available, that may include time aliased portions of the right overlap region of the inverse MDCT output. We show an example where an time interval on which HPF is applied is equal to the current frame, but different intervals may be used. The location of the HPF current input/output, the HPF past output and the IMDCT look-ahead relative to the MDCT/IMDCT windows is illustrated by FIG. 18a showing also the overlapping part that may be added as usual to produce Overlap-and-Add.

If it is signaled in the bit-stream that the HPF should use constant parameters, a smoothing is used at the beginning of the current frame, followed by the HPF with constant parameters on the remaining of the frame. Alternatively, a pitch analysis may be performed on y_{C} to decide if constant parameters should be used. The length of the region where the smoothing is used may be dependent on pitch parameters.

When constant parameters are not signaled, the HPF input is split into overlapping sub-intervals of length Lₖ with the hop size L_{k,update}=Lₖ/2. Other hop sizes may be used. The overlap length may be L_{k,update}−Lₖ or smaller. Lₖ is chosen so that no significant pitch change is expected within the sub-intervals. In an example L_{k,update} is an integer closest to pitch_mid/2, but not greater than pitch_mid/2, and Lₖ is set to 2L_{k,update}. Instead of pitch_mid some other values may be used, for example mean of pitch_mid and pitch_start or a value obtained from a pitch analysis on y_{C} or for example an expected minimum pitch lag in the interval for signals with varying pitch. Alternatively a fixed number of sub-intervals may be chosen. In another example it may be additionally requested that the frame length is divisible by L_{k,update} (cf FIG. 18b).

We say that the number of sub-intervals in the current interval k is Kₖ, in the previous interval k−1 is Kₖ₋₁ and in the following interval k+1 is Kₖ₊₁. In the example in FIG. 18b Kₖ=6 and Kₖ₋₁=4.

In other example it is possible that the current (time) interval is split into non integer number of sub-intervals and/or that the length of the sub-intervals change within the current interval as shown below. This is illustrated by FIGS. 18c and 18d.

For each sub-interval l in the current interval k (1≤l≤Kₖ), sub-interval pitch lag p_{k,l} is found using a pitch search algorithm, which may be the same as the pitch search used for obtaining the pitch contour or different from it. The pitch search for sub-interval l may use values derived from the coded pitch lag (pitch_mid, pitch_end) to reduce the complexity of the search and/or to increase the stability of the values p_{k,l} across the sub-intervals, for example the values derived from the coded pitch lag may be the values of the pitch contour. In other example, parameters found by a global pitch analysis in the complete interval of y_{C} may be used instead of the coded pitch lag to reduce the complexity of the search and/or the stability of the values p_{k,l} across the sub-intervals. In another example, when searching for the sub-interval pitch lag, it is assumed that an intermediate output of the harmonic post-filtering for previous sub-intervals is available and used in the pitch search (including sub-intervals of the previous intervals).

The N_{ahead} (potentially time aliased) look-ahead samples may also be used for finding pitch in sub-intervals that cross the interval/frame border or, for example if the look-ahead is not available, a delay may be introduced in the decoder in order to have look-ahead for the last sub-interval in the interval. Alternatively a value derived from the coded pitch lag (pitch_mid, pitch_end) may be used for p_{k,K}_{ₖ}.

For the harmonic post-filtering, the gain adaptive harmonic post-filter may be used. In the example the HPF has the transfer function:

$$H ( z ) = \frac{1 - αβ hB ( z , 0 )}{1 - β hgB ( z , {T}_{fr} ) {z}^{- {T}_{int}}}$$

where B(z,T_{fr}) is a fractional delay filter. B(z,T_{fr}) may be the same as the fractional delay filters used in the LTP or different from them, as the choice is independent. In the HPF, B(z,T_{fr}) acts also as a low-pass (or a tilt filter that de-emphasizes the high frequencies). An example for the difference equation for the gain adaptive harmonic post-filter with the transfer function H(z) and bⱼ(T_{fr}) as coefficients of B(z,T_{fr}) is:

$$y [ n ] = x [ n ] - β h ( α {\sum }_{i = - m}^{m + 1} {b}_{i} ( 0 ) x [ n + i ] - g {\sum }_{j = - m}^{m + 1} {b}_{j} ( {T}_{fr} ) y [ n - {T}_{int} + j ] )$$

Instead of a low-pass filter with a fractional delay, the identity filter may be used, giving B (z,T_{fr})=1 and the difference equation:

y[n]=x[n]−βh(ax[n]−gy[n−Tᵢₙₜ])

The parameter g is the optimal gain. It models the amplitude change (modulation) of the signal and is signal adaptive.

The parameter h is the harmonicity level. It controls the desired increase of the signal harmonicity and is signal adaptive. The parameter β also controls the increase of the signal harmonicity and is constant or dependent on the sampling rate and bit-rate. The parameter β may also be equal to 1. The value of the product flh should be between 0 and 1, 0 producing no change in the harmonicity and 1 maximally increasing the harmonicity. In practice it is usual that βh<0.75.

The feed-forward part of the harmonic post-filter (that is 1−αβhB(z,0)) acts as a high-pass (or a tilt filter that de-emphasizes the low frequencies). The parameter α determines the strength of the high-pass filtering (or in another words it controls the de-emphasis tilt) and has value between 0 and 1. The parameter a is constant or dependent on the sampling rate and bit-rate. Value between 0.5 and 1 is advantageous in embodiments.

For each sub-interval, optimal gain g_{k,l} and harmonicity level h_{k,l} is found or in some cases it could be derived from other parameters.

For a given B(z,T_{fr}) we define a function for shifting/filtering a signal as:

$${y}^{- p} [ n ] = {\sum }_{j = - 1}^{2} {b}_{j} ( {T}_{fr} ) {y}_{H} [ n - {T}_{int} + j ] , {T}_{int} = ⌊ p ⌋ , {T}_{fr} = p - {T}_{int} \\ \overline{{y}_{C}} [ n ] = {y}_{C}^{- 0} [ n ] \\ {y}_{L , l} [ n ] = {y}_{C} [ n + ( l - 1 ) L ]$$

With these definitions y_{L,l}[n] represents for 0≤n<L the signal y_{C} in a (sub-)interval l with length L, y̅_̅{̅C̅}̅ represents filtering of y_{C} with B (z, 0), y^{-p} represents shifting of y_{H} for (possibly fractional) p samples.

We define normalized correlation normcorr(y_{C}, y_{H}, l, L, p) of signals y_{C} and y_{H} at (sub-)interval l with length L and shift p as:

$$normcorr ( {y}_{C} , {y}_{H} , l , L , p ) = \frac{{\sum }_{n = 0}^{L - 1} {\overline{y}}_{L , l} [ n ] {y}_{L , l}^{- p} [ n ]}{\sqrt{{\sum }_{n = 0}^{L - 1} {( {\overline{y}}_{L , l} [ n ] )}^{2} {\sum }_{n = 0}^{{L}_{k} - 1} {( {y}_{L , l}^{- p} [ n ] )}^{2}}}$$

An alternative definition of normcorr(y_{C}, y_{H}, l, L, p) may be:

$$normcorr ( {y}_{C} , {y}_{H} , l , L , p ) = {\sum }_{j = - 1}^{2} {b}_{j} ( {T}_{fr} ) \frac{{\sum }_{n = 0}^{L - 1} {\overline{y}}_{L , l} [ n ] {y}_{L , l} [ n - {T}_{int} ]}{\sqrt{{\sum }_{n = 0}^{L - 1} {( {y}_{L , l} [ n ] )}^{2} {\sum }_{n = 0}^{{L}_{k} - 1} {( {y}_{L , l} [ n - {T}_{int} ] )}^{2}}}$$

$${T}_{int} = ⌊ p ⌋ , {T}_{fr} = p - {T}_{int}$$

In the alternative definition y_{L,l}[n−Tᵢₙₜ] represents y_{H} in the past sub-intervals for n<Tᵢₙₜ. In the definitions above we have used the 4^{th} order B (z,T_{fr}). Any other order may be used, needing change in the range for j. In the example where B(z,T_{fr})=1, we get y̅=y_{C} and y^{-p}[n]=y_{H}[n−└p┘] which may be used if only integer shifts are considered.

The normalized correlation defined in this manner allows calculation for fractional shifts p.

The parameters of normcorr l and L define the window for the normalized correlation. In the above definition rectangular window is used. Any other type of window (e.g. Hann, Cosine) may be used instead which can be done multiplying y̅_{L,l}[n] and y_{L,l}^{-p}[n] with w[n] where w[n] represents the window.

To get the normalized correlation on a sub-interval we would set l to the interval number and L to the length of the sub-interval.

The output of y_{L,l}^{-p}[n] represents the ZIR of the gain adaptive harmonic post-filter H(z) for the sub-frame l, with β=h=g=1 and Tᵢₙₜ=└p┘ and T_{fr}=p−Tᵢₙₜ.

The optimal gain g m models the amplitude change (modulation) in the sub-frame l. It may be for example calculated as a correlation of the predicted signal with the low passed input divided by the energy of the predicted signal:

$${g}_{k , l} = \frac{{\sum }_{n = 0}^{{L}_{k} - 1} {\overline{y}}_{{L}_{k} , l} [ n ] {y}_{{L}_{k} , l}^{- {p}_{k , l}} [ n ]}{{\sum }_{n = 0}^{{L}_{k} - 1} {( {y}_{{L}_{k} , l}^{- {p}_{k , l}} [ n ] )}^{2}}$$

In another example the optimal gain g m may be calculated as the energy of the low passed input divided by the energy of the predicted signal:

$${g}_{k , l} = \frac{{\sum }_{n = 0}^{{L}_{k} - 1} {( {\overline{y}}_{{L}_{k} , l} [ n ] )}^{2}}{{\sum }_{n = 0}^{{L}_{k} - 1} {( {y}_{{L}_{k} , l}^{- {p}_{k , l}} [ n ] )}^{2}}$$

The harmonicity level h_{k,l} controls the desired increase of the signal harmonicity and can be for example calculated as square of the normalized correlation:

h_{k,l}'normcorr(y_{C},y_{H},l,Lₖ,p_{k,l})²

Usually the normalized correlation of a sub-interval is already available from the pitch search at the sub-interval.

The harmonicity level h_{k,l} may also be modified depending on the LTP and/or depending on the decoded spectrum characteristics. For an example we may set:

h_{k,l}=h_{modLTP}h_{modTilt}normcorr(y_{C},y_{H},l,Lₖ,p_{k,l})²

where h_{modLTP} is a value between 0 and 1 and proportional to the number of harmonics predicted by the LTP and h_{modTilt} is a value between 0 and 1 and inverse proportional to a tilt of X_{C}. In an example h_{modLTP}=0.5 if n_{LTP} is zero, otherwise h_{modLTP}=0.7+0.3n_{LTP}/N_{LTP}. The tilt of X_{C}, may be the ratio of the energy of the first 7 spectral coefficients to the energy of the following 43 coefficients.

Once we have calculated the parameters for the sub-interval l, we can produce the intermediate output of the harmonic post-filtering for the part of the sub-interval l that is not overlapping with the sub-interval l+1. As written above, this intermediate output is used in finding the parameters for the subsequent sub-intervals.

Each sub-interval is overlapping and a smoothing operation between two filter parameters is used. The smoothing as described in [3] may be used. Below, embodiments will be discussed

Embodiments provided an audio encoder for encoding an audio signal comprising a pulse portion and a stationary portion, comprising: a pulse extractor configured for extracting the pulse portion from the audio signal, the pulse extractor comprising a pulse coder for encoding the pulse portions to acquire an encoded pulse portion; the pulse portion(s) may consist of pulse waveforms (having high-pass characteristics) located at peaks of a temporal envelope obtained from (possibly non-linear) (magnitude) spectrogram of the audio signal, a signal encoder configured for encoding a residual signal derived from the audio signal to acquire an encoded residual signal, the residual signal being derived from the audio signal so that the pulse portion is reduced or eliminated from the audio signal; and an output interface configured for outputting the encoded pulse portion and the encoded residual signal, to provide an encoded signal, wherein the pulse coder is configured for not providing an encoded pulse portion, when the pulse extractor is not able to find an impulse portion in the audio signal, the spectrogram having higher time resolution than the signal encoder.

According to further embodiments there is provided an audio encoder (as discussed), in which each pulse waveform has more energy near its temporal center than away from its temporal center.

According to further embodiments there is provided an audio encoder (as discussed), in which the temporal envelope is obtained by summing up values of the (possibly non-linear) magnitude spectrogram in one time instance.

According to further embodiments there is provided an audio encoder, in which the pulse waveforms are obtained from the (non-linear) magnitude spectrogram and a phase spectrogram of the audio signal by removing stationary part of the signal in all time instances of the magnitude spectrogram.

According to further embodiments there is provided an audio encoder (as discussed), in which the pulse waveforms have high-pass characteristics, having more energy at frequencies starting above a start frequency, the start frequency being proportional to the inverse of the average distance between the nearby pulse waveforms.

According to further embodiments there is provided an audio encoder (as discussed), in which a decision which pulse waveforms belong to the pulse portion is dependent on one of:
a correlation between pulse waveforms, and/or
a distance between the pulse waveforms, and/or
a relation between the energy of the pulse waveforms and the audio or residual signal.

According to further embodiments there is provided an audio encoder (as discussed), in which the pulse waveforms are coded by a spectral envelope common to pulse waveforms close to each other and by parameters for presenting a spectrally flattened pulse waveform.

Another embodiment provides a decoder for decoding an encoded audio signal comprising an encoded pulse portion and an encoded residual signal, comprising:
an impulse decoder configured for decoding the encoded pulse portion using a decoding algorithm adapted to a coding algorithm used for generating the encoded pulse portion, wherein a decoded pulse portion is acquired;
a signal decoder configured for decoding the encoded residual signal using a decoding algorithm adapted to a coding algorithm used for generating the encoded residual signal, wherein a decoded residual signal is acquired; and
a signal combiner configured for combining the decoded pulse portion and the decoded residual signal to provide a decoded output signal, wherein the signal decoder and the impulse decoder are operative to provide output values related to the same time instance of a decoded signal,
wherein the impulse decoder is operative to receive the encoded pulse portion and provide the decoded pulse portion consisting of pulse waveforms located at specified time portions and the encoded impulse like signal includes parameters for presenting a spectrally flattened pulse waveforms, where each pulse waveform has more energy near its temporal center than away from its temporal center.

Further embodiments provide an audio decoder (as discussed), in which the impulse decoder obtains the spectrally flattened pulse waveform using a prediction from a previous (flattened) pulse waveform.

Further embodiments provide an audio decoder (as discussed), in which the impulse decoder obtains the pulse waveforms by spectrally shaping the spectrally flattened pulse waveforms using spectral envelope common to pulse waveforms close to each other (e.g. in sense of subsequent to each other in the current frame).

According to embodiments, the encoder may comprise a band-wise parametric coder configured to provide a coded parametric representation (zfl) of the spectral representation (X_{MR}) depending on the quantized representation (X_{Q}), wherein a spectral representation of audio signal (X_{MR}) divided into a plurality of sub-bands, wherein the spectral representation (X_{MR}) consists of frequency bins or of frequency coefficients and wherein at least one sub-band contains more than one frequency bin; wherein the coded parametric representation (zfl) consists of a parameter describing energy in sub-bands or a coded version of parameters describing energy in sub-bands; wherein there are at least two sub-bands being and, thus, parameters describing energy in at least two sub-bands being different. Note, it is advantageous to use a parametric representation in the MDCT of the residual, because parametrically presenting the pulse portion (P) in sub-bands of the MDCT needs many bits and because the residual (R) signal has many sub-bands that can be well parametrically coded.

According to embodiments, the decoder further comprises means for zero filling configured for performing a zero filling. Furthermore, the decoder may according to further embodiments, comprise a spectral domain decoder and a band-wise parametric decoder, the spectral domain decoder configured for generating a decoded spectrum (X_{D}) from a coded representation of spectrum (spect) and dependent on a quantization step (g_{Q}_{₀}), wherein the decoded spectrum (X_{D}) is divided into sub-bands; the band-wise parametric decoder (1210, 162) configured to identify zero sub-bands in the decoded spectrum (X_{D}) and to decode a parametric representation of the zero sub-bands (E_{B}) based on a coded parametric representation (zfl) wherein the parametric representation (E_{B}) comprises parameters describing energy in sub-bands and wherein there are at least two sub-bands being different and, thus, parameters describing energy in at least two sub-bands being different and/or wherein the coded parametric representation (zfl) is coded by use of a variable number of bits and/or wherein the number of bits used for representing the coded parametric representation (zfl) is dependent on the spectral representation of audio signal (X_{MR}).

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] O. Niemeyer and B. Edler, “Detection and Extraction of Transients for Audio Coding,” in Audio Engineering Society Convention 120, 2006.
[2] J. Herre, R. Geiger, S. Bayer, G. Fuchs, U. Krämer, N. Rettelbach, and B. Grill, “Audio Encoder For Encoding An Audio Signal Having An Impulse-Like Portion And Stationary Portion, Encoding Methods, Decoder, Decoding Method; And Encoded Audio Signal,” PCT/EP2008/004496, 2007.
[3] F. Ghido, S. Disch, J. Herre, F. Reutelhuber, and A. Adami, “Coding Of Fine Granular Audio Signals Using High Resolution Envelope Processing (HREP),” in 2017 IEEE International Conference on Acoustics, Speech and Signal Processing (ICASSP), 2017, pp. 701-705.
[4] A. Adami, A. Herzog, S. Disch, and J. Herre, “Transient-to-noise ratio restoration of coded applause-like signals,” in 2017 IEEE Workshop on Applications of Signal Processing to Audio and Acoustics (WASPAA), 2017, pp. 349-353.
[5] R. Füg, A. Niedermeier, J. Driedger, S. Disch, and M. Müller, “Harmonic-percussive-residual sound separation using the structure tensor on spectrograms,” in 2016 IEEE International Conference on Acoustics, Speech and Signal Processing (ICASSP), 2016, pp. 445-449.
ADDIN Docear CSL_BIBLIOGRAPHY[6] C. Helmrich, J. Lecomte, G. Markovic, M. Schnell, B. Edler, and S. Reuschl, “Apparatus And Method For Encoding Or Decoding An Audio Signal Using A Transient-Location Dependent Overlap,” PCT/EP2014/053293, 2014.
[7] 3rd Generation Partnership Project; Technical Specification Group Services and System Aspects; Codec for Enhanced Voice Services (EVS); Detailed algorithmic description, no. 26.445. 3GPP, 2019.
[8] G. Markovic, E. Ravelli, M. Dietz, and B. Grill, “Signal Filtering,” PCT/EP2018/080837, 2018.
[9] E. Ravelli, C. Helmrich, G. Markovic, M. Neusinger, S. Disch, M. Jander, and M. Dietz, “Apparatus and Method for Processing an Audio Signal Using a Harmonic Post-Filter,” PCT/EP2015/066998, 2015.

1. Audio encoder for encoding an audio signal comprising:
a pulse extractor configured for extracting a pulse portion from the audio signal wherein the pulse extractor is configured to determine a spectrogram of the audio signal to extract the pulse portion;
a pulse coder for encoding the extracted pulse portion to acquire an encoded pulse portion;
a signal encoder configured for encoding a residual signal derived from the audio signal to acquire an encoded residual signal, the residual signal being derived from the audio signal by reducing or eliminating the pulse portion from the audio signal; wherein the spectrogram comprises higher time resolution than the signal encoder; and
an output interface configured for outputting the encoded pulse portion and the encoded residual signal to provide an encoded signal.

2. Audio encoder according to claim 1, wherein the pulse coder is configured for providing an information that the encoded pulse portion is not present when the pulse extractor is not able to find a pulse portion in the audio signal; and/or
where the pulse portion is derived from the spectrogram of the audio signal.

3. Audio encoder according to claim 1, wherein the signal encoder is configured for coding the residual signal or the residual comprising a stationary portion of the audio signal; and/or
wherein the signal encoder is advantageously a frequency domain encoder; and/or
wherein the signal encoder is more advantageously an MDCT encoder; and/or
wherein the signal encoder is configured to perform MDCT coding.

4. Audio encoder according to claim 1, wherein the pulse extractor is configured to acquire the pulse portion comprising pulse waveforms; or
wherein the pulse extractor is configured to acquire the pulse portion comprising pulses or pulse waveforms, wherein the pulses or the pulse waveforms are located at or near peaks of a temporal envelope acquired from the spectrogram of the audio signal or wherein the pulse extractor is configured to uniquely determine each pulse of the pulses by a position and pulse waveform.

5. Audio encoder according to claim 1, further comprising a highpass filter configured to process the audio signal so that each pulse waveform of the pulse portion comprises a high-pass characteristic and/or a characteristic comprising more energy at frequencies starting above a start frequency and configured to process the audio signal so that the high-pass characteristic within the residual signal is removed or reduced; and/or
further comprising a filter configured to process an enhanced spectrogram, wherein the enhanced spectrogram is derived from the spectrogram of the audio signal, or the pulse portion so that each pulse waveform of the pulse portion comprises a high-pass characteristic and/or a characteristic comprising more energy at frequencies starting above a start frequency, where the start frequency being proportional to the inverse of an average distance estimation between nearby pulses; and/or
wherein each pulse waveform comprises a characteristic comprising more energy at frequencies starting above a start frequency.

6. Audio encoder according to claim 4, further comprising a processor for processing the spectrogram of the audio signal or an enhanced spectrogram derived from the spectrogram of the audio signal, such that each pulse or pulse waveform comprises a characteristic of more energy near its temporal center than away from its temporal center or such that the pulses or the pulse waveforms are located at or near peaks of a temporal envelope acquired from the spectrogram of the audio signal.

7. Audio encoder according to claim 1, wherein the spectrogram is out of the group comprising:
a magnitude spectrogram;
a magnitude and a phase spectrogram;
a non-linear magnitude spectrogram;
a non-linear magnitude and a phase spectrogram; and/or
wherein the pulse extractor is configured to determine the spectrogram, especially the spectrogram of the audio signal and/or the enhanced spectrogram, as to extract the pulse portion.

8. Audio encoder according to claim 7, wherein the pulse extractor is configured to acquire at least one sample of the temporal envelope or the temporal envelope in at least one time instance by summing up values of a magnitude spectrum in at least one time instance, where the magnitude spectrogram comprises at least one magnitude spectrum, and/or by summing up values of a non-linear magnitude spectrum in at least one time instance, where the non-linear magnitude spectrogram comprises at least one non-linear magnitude spectrum.

9. Audio encoder according claim 1, wherein the pulse extractor is configured to acquire the pulse portion from the spectrogram of the audio signal by removing or reducing a stationary portion of the audio signal in all time instances of the spectrogram; and/or by setting to zero and/or by reducing the spectrogram below a start frequency, where the start frequency being proportional to the inverse of an average distance between nearby pulse waveforms.

10. Audio encoder according to claim 1, wherein the pulse coder is configured to encode the extracted pulse portion of a current frame taking into account the extracted pulse portion or extracted pulse portions of one or more frames previous to the current frame.

11. Audio encoder according to claim 1, wherein the pulse extractor is configured to determine pulse waveforms belonging to the pulse portion dependent on one of:
a correlation between pulse waveforms, and/or
a distance between the pulse waveforms, and/or
a relation between the energy of the pulse waveforms and the audio signal or a relation between the energy of the pulse waveforms and a stationary portion or a relation between the energy of the audio signal and a stationary portion.

12. Audio encoder according to claim 1, wherein the pulse coder is configured to code the extracted pulse portion by a spectral envelope common to pulse waveforms close to each other and by parameters for presenting a spectrally flattened pulse waveform, where the extracted pulse portion comprises the pulse waveforms and the spectrally flattened pulse waveform is acquired from the pulse waveform using the spectral envelope or a coded spectral envelope.

13. Audio encoder according to claim 4, wherein the pulse coder is configured to spectrally flatten the pulse waveform or a pulse Short-time Fourier Transform using a spectral envelope; and/or
further comprising a filter processor configured to spectrally flatten the pulse waveform by filtering the pulse waveform in time domain; and/or
wherein the pulse coder is configured to acquire a spectrally flattened pulse waveform from a spectrally flattened Short-time Fourier Transform via inverse Discrete Fourier Transform, window and overlap-and-add.

14. Audio encoder according to claim 1, further comprising a coding entity configured to code or code and quantize a gain for a prediction residual signal, where the prediction residual signal is acquired based on a past pulse portion.

15. Audio encoder according to claim 14, further comprising a correction entity configured to calculate for and/or apply a correction factor to the gain for the prediction residual signal.

16. Audio encoder according to claim 1, further comprising a band-wise parametric coder configured to provide a coded parametric representation of a spectral representation, wherein the spectral representation of the audio signal is acquired from the residual signal using a time to frequency transform, wherein the spectral representation of the audio signal is divided into a plurality of sub-bands, wherein the spectral representation comprises frequency bins or of frequency coefficients and wherein at least one sub-band comprises more than one frequency bin; wherein the coded parametric representation comprises a parameter describing sub-bands or a coded version of parameters describing sub-bands; wherein there are at least two sub-bands being different and, thus, parameters describing at least two sub-bands being different.

17. Audio encoder according to claim 1, wherein the pulse extractor is configured to determine positions of pulses as local peaks in a smoothed temporal envelope with the requirement that the peaks are above their surroundings; where the smoothed temporal envelope is low-pass filtered version of a temporal envelope acquired from the spectrogram of the audio signal; and/or
wherein the pulse extractor is configured to determine positions of pulses and wherein the pulse coder is configured to code an information on the positions of pulses as part of the encoded pulse portion; and/or
wherein the pulse extractor is configured to uniquely determine each pulse by a position and pulse waveform; and/or
wherein the pulse extractor is configured to determine peaks in a temporal envelope, considered as positions of pulses or of transients, where the temporal envelope is acquired by summing up values of a magnitude spectrogram.

18. Method for encoding an audio signal, comprising:
extracting a pulse portion from the audio signal by determining a spectrogram of the audio signal, wherein the spectrogram comprises higher time resolution than a signal encoder;
encoding the extracted pulse portion to acquire an encoded pulse portion;
encoding a residual signal derived from the audio signal to acquire an encoded residual signal, the residual signal being derived from the audio signal by reducing or eliminating the pulse portion from the audio signal; and
outputting the encoded pulse portion and the encoded residual signal to provide an encoded signal.

19. Decoder for decoding an encoded audio signal comprising an encoded pulse portion and an encoded residual signal, comprising:
a pulse decoder configured for using a decoding algorithm adapted to a coding algorithm used for generating the encoded pulse portion to acquire a decoded pulse portion;
a signal decoder configured for using a decoding algorithm adapted to a coding algorithm used for generating the encoded residual signal to acquire the decoded residual signal; and
a signal combiner configured for combining the decoded pulse portion and the decoded residual signal to provide a decoded output signal;
wherein the signal decoder and the pulse decoder are operative to provide output values related to the same time instance of a decoded signal; and
the signal decoder operates in the frequency domain comprising frequency to time transform; and
wherein the decoded pulse portion comprises pulse waveforms located at specified time portions, an information on the specified time portions being a part of the encoded pulse portion; and
wherein the encoded pulse portion comprises parameters for presenting spectrally flattened pulse waveforms; and
wherein the decoded pulse portion comprises pulse waveforms and the pulse decoder is configured to acquire the pulse waveforms by spectrally shaping spectrally flattened pulse waveforms using a spectral envelope common to pulse waveforms close to each other.

20. Decoder according to claim 19,
where each pulse waveform comprises a characteristic of more energy near its temporal center than away from its temporal center.

21. Decoder according to claim 19, wherein the encoded audio signal comprises the encoded pulse portion and the encoded residual, the encoded pulse portion comprising high pass characteristics; and/or
wherein the encoded audio signal being encoded by use of an encoder comprising:
a pulse extractor configured for extracting a pulse portion from the audio signal wherein the pulse extractor is configured to determine a spectrogram of the audio signal to extract the pulse portion;
a pulse coder for encoding the extracted pulse portion to acquire an encoded pulse portion;
a signal encoder configured for encoding a residual signal derived from the audio signal to acquire an encoded residual signal, the residual signal being derived from the audio signal by reducing or eliminating the pulse portion from the audio signal; wherein the spectrogram comprises higher time resolution than the signal encoder; and
an output interface configured for outputting the encoded pulse portion and the encoded residual signal to provide an encoded signal.

22. Decoder according to claim 19, wherein the pulse decoder is configured to acquire a spectrally flattened pulse waveform using a prediction from a previous pulse waveform or a previous flattened pulse waveform.

23. Decoder according to claim 21 wherein the encoded pulse portion comprises a pulse starting frequency f_{P}_{ᵢ}, wherein the high pass characteristics is determined by modifying the pulse waveforms to comprise more energy at frequencies starting above the pulse starting frequency f_{P}_{ᵢ}.

24. Decoder according to claim 19, further comprising a filler for zero filling configured for performing a zero filling;
further comprising a spectral domain decoder and a band-wise parametric decoder, the spectral domain decoder configured for generating a decoded spectrum from a coded representation of the encoded residual, wherein the decoded spectrum is divided into sub-bands; the band-wise parametric decoder configured to identify zero sub-bands in the decoded spectrum and to decode a parametric representation of the zero sub-bands based on a coded parametric representation wherein the parametric representation comprises parameters describing sub-bands and wherein there are at least two sub-bands being different and, thus, parameters describing at least two sub-bands being different and/or wherein the coded parametric representation is coded by use of a variable number of bits.

25. Decoder according to claim 19, further comprising a harmonic post-filter configured for reducing the decoded output signal between harmonics.

26. Decoder according to claim 19, wherein the pulse decoder is configured to decode the encoded pulse portion of a current frame taking into account the encoded pulse portion or encoded pulse portions of one or more frames previous to the current frame.

27. Decoder according to claim 19, wherein the pulse decoder is configured to acquire a spectrally flattened pulse waveform taking into account a prediction gain directly extracted from the encoded pulse portion.

28. Method for decoding an encoded audio signal comprising an encoded pulse portion and an encoded residual signal, the method comprising:
using a pulse decoding algorithm adapted to a coding algorithm used for generating the encoded pulse portion to acquire a decoded pulse portion;
using a signal decoding algorithm adapted to a coding algorithm used for generating the encoded residual signal to acquire the decoded residual signal; and
combining the decoded pulse portion and the decoded residual signal to provide a decoded output signal;
wherein the signal decoding algorithm is operative to provide output values related to the same time instance of a decoded signal; and
the signal decoding algorithm operates in the frequency domain comprising frequency to time transform; and
wherein the decoded pulse portion comprises pulse waveforms located at specified time portions, an information on the specified time portions being a part of the encoded pulse portion; and
wherein the encoded pulse portion comprises parameters for presenting spectrally flattened pulse waveforms; and
wherein the decoded pulse portion comprises pulse waveforms and the pulse decoding algorithm is operative to acquire the pulse waveforms by spectrally shaping spectrally flattened pulse waveforms using a spectral envelope common to pulse waveforms close to each other.

29. A non-transitory digital storage medium having a computer program stored thereon to perform the method for encoding an audio signal, the method comprising:
extracting a pulse portion from the audio signal by determining a spectrogram of the audio signal, wherein the spectrogram comprises higher time resolution than a signal encoder;
encoding the extracted pulse portion to acquire an encoded pulse portion;
encoding a residual signal derived from the audio signal to acquire an encoded residual signal, the residual signal being derived from the audio signal by reducing or eliminating the pulse portion from the audio signal; and
outputting the encoded pulse portion and the encoded residual signal to provide an encoded signal,
when said computer program is run by a computer.

30. A non-transitory digital storage medium having a computer program stored thereon to perform the method for decoding an encoded audio signal comprising an encoded pulse portion and an encoded residual signal, the method comprising:
using a pulse decoding algorithm adapted to a coding algorithm used for generating the encoded pulse portion to acquire a decoded pulse portion;
using a signal decoding algorithm adapted to a coding algorithm used for generating the encoded residual signal to acquire the decoded residual signal; and
combining the decoded pulse portion and the decoded residual signal to provide a decoded output signal;
wherein the signal decoding algorithm is operative to provide output values related to the same time instance of a decoded signal; and
the signal decoding algorithm operates in the frequency domain comprising frequency to time transform; and
wherein the decoded pulse portion comprises pulse waveforms located at specified time portions, an information on the specified time portions being a part of the encoded pulse portion; and
wherein the encoded pulse portion comprises parameters for presenting spectrally flattened pulse waveforms; and
wherein the decoded pulse portion comprises pulse waveforms and the pulse decoding algorithm is operative to acquire the pulse waveforms by spectrally shaping spectrally flattened pulse waveforms using a spectral envelope common to pulse waveforms close to each other,
when said computer program is run by a computer.
